(19) United States
(12) Patent Application Publication
(10) Pub. No.: US 2006/0275618 A1
(43) Pub. Date: Dec. 7, 2006

(54) Display device

(75) Inventors: Toshihiro Kugimiya, Kobe-shi (JP); Katsufumi Tomihisa, Kobe-shi (JP); Aya Hino, Kobe-shi (JP); Katsutoshi Takagi, Kobe-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/431,580

(22) Filed: May 11, 2006

(30) Foreign Application Priority Data
Sep. 20, 2005 (JP) 2005-272643
Jun. 7, 2005 (JP) 2005-167185

(51) Int. Cl. B32B 15/04; B32B 9/00

(52) U.S. Cl. 428/469; 428/701

(57) ABSTRACT

A display device in which interconnection—electrode comprising a Cu alloy film having a lower electrical resistivity than Al alloy and a transparent conductive film are directly connected not by way of a refractory metal thin film, wherein the Cu alloy film contains Zn and/or Mg in a total amount from 0.1 to 3.0 at %, or Ni and/or Mn in a total amount from 0.1 to 5 at %, thereby enabling the direct connection at low resistivity between the Cu alloy film and the transparent electrode without using a barrier metal, and giving high display quality in a case of application, for example, to a liquid crystal display.

### BACKGROUND OF THE INVENTION

1. Field of the Invention

The present invention concerns a thin film display device and, more in particular, it relates to a novel display device including, as a constituent element, a low electrical resistivity interconnection portion of a structure in which a transparent conductive film and a Cu alloy film are connected directly, which is used, for example, inactive and passive matrix type flat displays (FPD) such as liquid crystal displays, reflective films, optical parts, etc.

2. Description of the Related Art

For FPD including liquid crystal displays, a demand for low electrical resistivity interconnection materials has been increased in recent years. Particularly, in the liquid crystal displays, lowering of the electrical resistivity for gate lines and signal lines (source and drain lines) of thin film transistors (TFTs) for driving pixels has been demanded strongly and, at present, heat resistant Al alloys such as Al—Nd have been used.

However, along with the advent of large-.sized panels of 40 or larger type such as for liquid crystal displays TV sets, Ag and Cu have attracted attention as materials of lower electrical resistivity than the Al alloys in view of the problem of signal delay in the gate lines and signal lines. However, Ag and Cu involve several problems in view of application for liquid crystal displays.

They are, for example, adhesion with glass substrates and SiN insulative films, fabricability of interconnections by wet etching, cohesion of Ag element, etc. in the case of pure Ag. Further, examples of using pure Cu metal or Cu alloy have been known, for example, in JP-A Nos. 2003-58079 and 2003-297584 and they have already been put to practical use in some high end monitors although they involve several problems like those in Ag as described above.

### SUMMARY OF THE INVENTION

One of the problems pointed out for the Cu metal and Cu alloy is that they are easily oxidized. In a case of Al alloy interconnections used generally at present, both of gate interconnections and source/drain interconnections are connected by way of a refractory metal referred to as a barrier metal such as Mo, Cr or alloys thereof between both of them upon connection with a transparent electrode such as made of indium tin oxide (ITO). This is because the electrical connection resistivity increases or electrical connection becomes impossible due to Al oxide films formed at the boundary between Al and ITO when ITO is in direct connection with Al.

Such a problem also occurs in a case of using pure Cu or Cu alloy film. This is because the surface of the Cu film is easily oxidized in atmospheric air to form Cu oxide films, and the Cu surface is easily oxidized also in an oxygen plasma ashing step which is used upon resist stripping. Further, in a case of forming an ITO film by sputtering on the surface of a Cu film for electrical connection of the Cu film and the ITO film, etc. as a transparent electrode, a thin oxide film is formed on the surface of the Cu film as the ITO/Cu boundary due to oxygen derived from a target material during formation of the ITO film or due to oxygen added during film formation. The oxide film increases the connection resistivity between the Cu interconnection and the transparent electrode, thereby deteriorating the display quality such as the gradation of liquid crystal displays.

A barrier metal such as Mo used so far between an Al alloy film and a transparent electrode has an affect of preventing oxidation on the surface of the Al alloy film and favorably keeping electrical resistivity between the Al alloy film and the transparent electrode and, also in a case of using Cu or Cu alloy instead of the Al alloy, use of the barrier metal is also effective.

However, in such existent method, since sputtering film-forming chamber that forms a barrier metal for forming a barrier metal layer such as of Mo is necessary, this increases the installation cost, as well as causes lowering of the productivity and increase of the cost due to the increase of the tact time during film formation. The present invention has been achieved in view of the foregoing situations and intends to provide a display device using a Cu alloy film having a lower electrical resistivity than that of Al alloys for connection with a transparent electrode film and capable of direct connection at low electrical resistivity relative to the transparent electrode without using a barrier metal layer and capable of ensuring high display quality in a case of application, for example, to liquid crystal displays.

To address the problem, an aspect of the invention is directed to a display device in which an interconnection—electrode comprising a Cu alloy film and a transparent conductive film are connected directly not by way of a refractory metal thin film, wherein the Cu alloy film contains Zn and/or Mg in a total amount from 0.1 to 3.0 at %, or Ni and/or Mn in a total amount from 0.1 to 0.5 at % or, and wherein the Cu alloy film further contains, Fe and/or Co in a total amount from 0.02 to 1.0 at % and 0.005 to 0.5 at % of P in addition to the element described above.

In the display device of the aspect of the invention, indium tin oxide (ITO) or indium zinc oxide (IZO) is preferred as the transparent conductive film, and those formed by laminating a transparent conductive film to a Cu alloy film containing the specified elements described above as a tab connection electrode are extremely useful, for example, as a liquid crystal display of low electrical connection resistivity and of high display quality.

The aspect of the invention is able to provide at a reduced cost a high performance display device capable obtaining direct contact between a Cu alloy film and a transparent conductive film such as of ITO or IZO at low contact resistance and capable of saving the use of a barrier metal layer.

According to the aspect of the invention described above, in a case where the transparent conductive film and a Cu metal film are in contact with each other, since at least one element selected from Zn, Mg, Ni, and Mn is contained by a small amount in the Cu metal film, it is possible to suppress the growing of the Cu oxide film formed on the surface of the Cu metal film thereby capable of controlling the contact resistance to a low and stable state and, accordingly, decreasing the number of steps and manufacturing cost remarkably while maintaining the display quality at a high level in a liquid crystal display or the like.

### BRIEF DESCRIPTION OF THE DRAWINGS

Embodiments of the present invention will be described in detail based on the following figures, wherein:

FIG. 1 is a schematic explanatory cross sectional view showing an example of a liquid crystal display structure mounted on a liquid crystal display device;

FIG. 2 is an enlarged explanatory cross sectional view showing an example of a cross sectional structure of a thin film transistor;

FIG. 3 is an enlarged explanatory cross sectional view explaining the steps of forming a thin film transistor structure successively;

FIG. 4 is an enlarged explanatory cross sectional view explaining the steps of forming a thin film transistor structure successively;

FIG. 5 is an enlarged explanatory cross sectional view explaining the steps of forming a thin film transistor structure successively;

FIG. 6 is an enlarged explanatory cross sectional view explaining the steps of forming a thin film transistor structure successively;

FIG. 7 is an enlarged explanatory cross sectional view explaining the steps of forming a thin film transistor structure successively;

FIG. 8 is an enlarged explanatory cross sectional view explaining the steps of forming a thin film transistor structure successively;

FIG. 9 is an enlarged explanatory cross sectional view explaining the steps of forming a thin film transistor structure successively;

FIG. 10 is a graph showing a relation between a heat treatment temperature and an electrical resistivity in several specimens used in the examples; and

FIG. 11 is a graph showing a relation between a heat treatment temperature and a void density in several specimens used in the examples.

### DETAILED DESCRIPTION OF THE PREFERRED EMBODIMENTS

A preferred embodiment of a display device according to the invention is to be described specifically as an example of an active matrix type display device with reference to the drawings but the invention is no way restricted to the illustrated embodiment but it can of course be practiced within an appropriate range capable of conforming to the gist of the invention described above and to be described later.

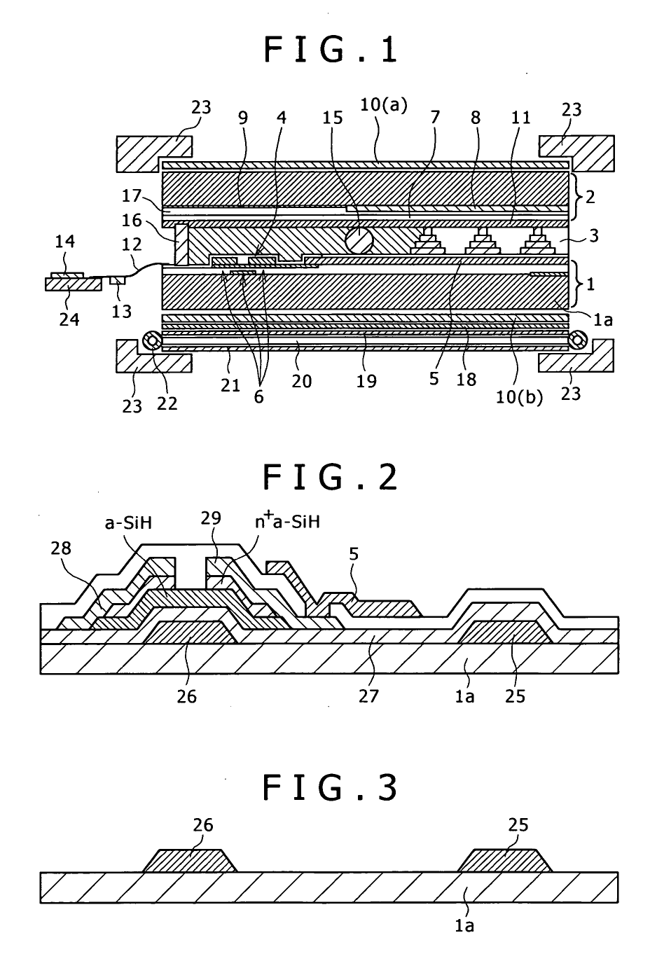

FIG. 1 is an schematic explanatory enlarged cross sectional view of a liquid crystal display structure mounted on a liquid crystal display device to which the invention is applied.

A liquid crystal display shown in FIG. 1 has a thin film transistor (TFT) array substrate 1, an opposing substrate 2 opposed to the TFT array substrate 1, and a liquid crystal layer 3 disposed between the TFT array substrate 1 and the opposing substrate 2 and functioning as a light modulation layer. The TFT array substrate 1 includes a thin film transistor (TFT) 4 disposed on an insulative glass substrate 1a, a transparent conductive film (pixel electrode) 5, and an interconnection portion 6 including scanning lines and signals lines.

The opposing substrate 2 includes a common electrode 7 formed over the entire surface on the side of the TFT array substrate 1, a color filter 8 disposed at a position opposing to the transparent conductive film 5 and a light screening film 9 disposed at a position opposing to the thin film transistor (TFT) 4 or the interconnection portion 6 over the TFT array substrate 1.

Further, polarization plates 10(a) and 10(b) are disposed on the outer surfaces of an insulative substrate constituting the TFT array substrate 1 and the opposing substrate 2, and an orientation film 11 for orienting liquid crystal molecules contained in the liquid crystal layer 3 to a predetermined direction is disposed to the opposing substrate 2.

In the liquid crystal display of such a structure, the orientation direction of the liquid crystal molecules in the liquid crystal layer 3 is controlled by an electrical field formed between the opposing substrate 2 and the transparent conductive film (pixel electrode) 5, and light passing through the liquid crystal layer 3 between the TFT array substrate 1 and the opposing substrate 2 is modulated, by which the amount of transmission light that transmits the opposing substrate 2 is controlled to display images.

Further, the TFT array is driven by a driver circuit 13 and a control circuit 14 by a TAB tape 12 which is led out to the outside of the TFT array.

In the drawing, are shown a spacer 15, a seal material 16, a protective film 17, a diffusion plate 18, a prism sheet 19, a light conductive plate 20, a reflective plate 21, a back light 22, a retaining flame 23, and a printed substrate 24, respectively.

FIG. 2 is an explanatory enlarged cross sectional view showing an example of a structure for a TFT portion applied to the array substrate adopted in the invention. As shown in FIG. 2, a scanning line 25 is formed by a Cu metal film on a glass substrate la, and a portion of the scanning line 25 functions as a gate electrode 26 that conducts on-off controls for the thin film transistor. Further, a signal line is formed by a Cu metal film so as to intersect the scanning line 25 by way of a gate insulative film 27, and a portion of the signal line functions as a source electrode 28 of the thin film transistor. This is generally called as a bottom gate type.

In the pixel region on the gate insulative film 27, a transparent conductive film 5 formed, for example, of an ITO film incorporated with about 10 mass % of SnO in In₂O₃. A drain electrode 29 of the thin film transistor formed with the Cu alloy film is connected electrically being in contact directly with the transparent conductive film 5.

When a gate voltage is applied from the gate electrode 26 by way of the scanning line 25 to the TFT array substrate 1, the thin film transistors is turned ON, and a driving voltage previously supplied to the signal line is supplied from the source electrode 28 by way of the drain electrode 29 to the transparent conductive 25. Then, when a driving voltage at a predetermined level is applied to the transparent conductive film 5, a potential difference is generated relative to the counter electrode 2, and liquid crystal molecules contained in the liquid crystal layer 3 are oriented to conduct light modulation (refer to FIG. 1).

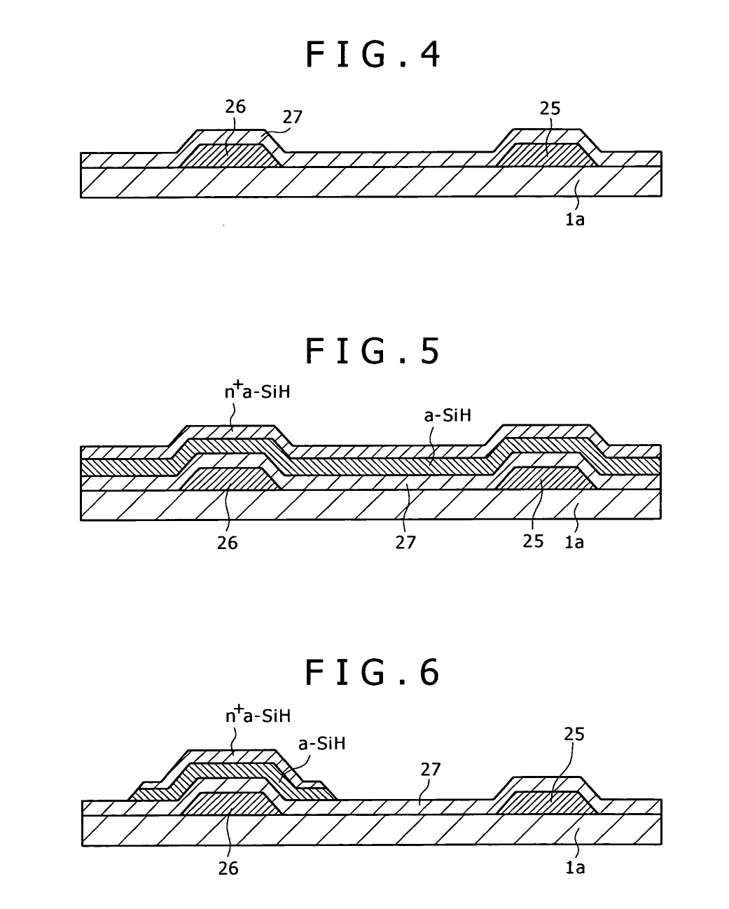

Then, the outline for the manufacturing steps of the TFT array substrate is to be described with reference to examples of FIG. 3 to FIG. 9. A thin film transistor formed as a switching element in this embodiment exemplifies an amorphous silicon TFT using hydrogenated amorphous silicon as a semiconductor layer. At first a thin Cu film of about 200 nm thickness was formed at first by sputtering over a glass substrate 1a, and the thin Cu film is patterned by wet etching to form a gate electrodes 26 and a scanning line 25 (FIG. 3). Then, as shown in FIG. 4, a gate insulative film (silicon nitride film: SiNₓ) 27 of about 300 nm thickness is formed at a substrate temperature of about 350° C. by a plasma CVD method or the like. A hydrogenated amorphous silicon film (a-SiH) of about 150 nm thickness and an n⁺-hydrogenated amorphous silicon film (n⁺ a-SiH) doped with P of about 50 nm thickness is formed continuously thereover at a substrate temperature of about 300° C. (FIG. 5).

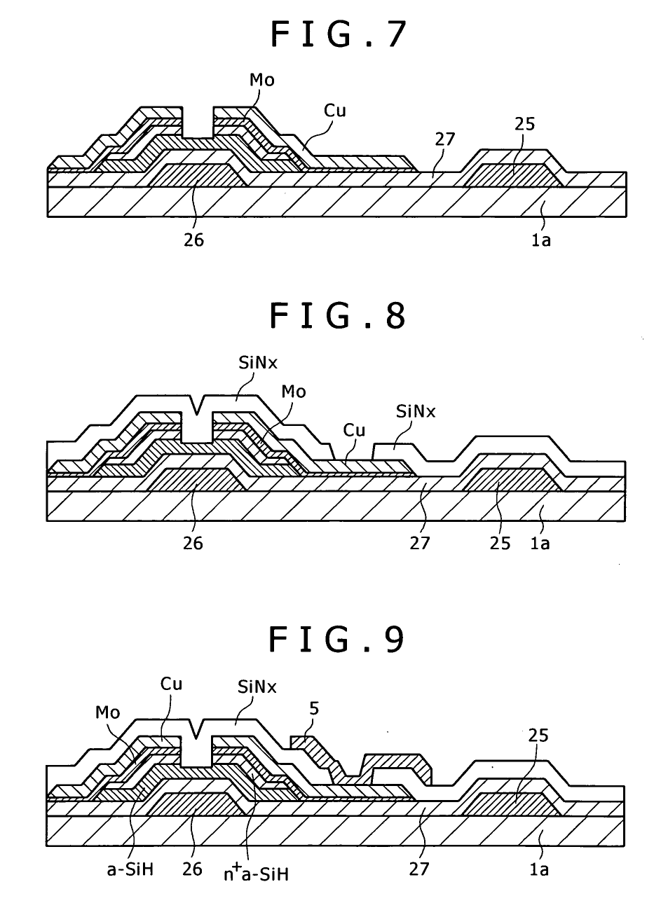

Successively, as shown in FIG. 6, the hydrogenated amorphous silicon film (a-SiH) and the n⁺-hydrogenated amorphous silicon film (n⁺ a-SiH) are patterned by dry etching. Then, as shown in FIG. 7, an Mo layer (underlayer) of about 50 nm thickness and a Cu metal layer of about 200 nm thickness were laminated and formed, and a Cu/Mo laminate film is patterned by wet etching to form a source electrode integrated with the signal line and a drain electrode in contact with the ITO transparent conductive film. Further, the n⁺ amorphous silicon film (n⁺ a-SiH) is removed by dry etching using the source electrode and the drain electrode as a mask.

Then, as shown in FIG. 8, a silicon nitride film (SiNx) is formed to a thickness of about 300 nm to form a protective film in a plasma CVD apparatus. The film is often formed at a film forming temperature, for example, of about 250° C. Then, the silicon nitride film (SiNx) is patterned and a contact hole is formed to the silicon nitride film (SiNx) by dry etching. Further, through a polymer removing step by oxygen plasma ashing and, after applying a stripping treatment for the photoresist using, for example, a non-amine type stripping solution, a Cu oxide film formed by oxygen plasma ashing is removed with a diluted hydrofluoric acid.

Finally, as shown in FIG. 9, an ITO transparent conductive film, for example, of about 150 nm thickness is formed by sputtering at a room temperature and patterned by wet etching to form a pixel electrode (ITO transparent conductive film) 5, to complete a TFT array substrate.

In the TFT array substrate formed in accordance with the manufacturing step, the ITO transparent conductive film (pixel electrode) 5 and the drain electrode formed with the Cu metal film are in direct contact with each other. Also, the ITO transparent conductive film 5 is in direct contact also with the TAB portion of the scanning line connected with the gate electrode. The display device of the invention is manufactured by the steps as described above and the most prominent feature of the invention is to incorporate selected specified elements each by a predetermined amount to Cu as a Cu alloy film for use in the interconnection portion, and the feature is to be described later. As the element contained in the Cu alloy film, Zn and/or Mg, or Ni and/or Mn are selected. The elements described above are selected as the elements which are solid soluble to the Cu metal but not solid soluble to the Cu oxide film. When the Cu alloy in which the elements described above are solid-solubilized is oxidized, since the elements (Zn, Ni, Mn, and Mg) are not solid-solubilized to the Cu oxide film, the elements are swept out and thickened below the boundary of the Cu oxide film formed by oxidation and, further growing of the Cu oxide film is suppressed by the thickened layer. Therefore, growing of the Cu oxide film is minimized also in the oxygen ashing or in the laminated film formation step with the ITO transparent conductive film.

Particularly, in the ITO lamination and film formation, the Cu alloy film and the transparent conductive film are kept in a favorable state of electrical contact.

For obtaining a low contact resistivity, for example, at an order of 10⁻⁵ Ω·cm² to 10⁻⁴ Ω·cm² by the formation of such a thickened layer, one or more of elements selected from Zn, Ni, Mn, and Mg described above are contained preferably by 0.1 at % or more, more preferably, 0.2 at % or more in total, by which a sufficient conductivity can be ensured by direct connection with no interposition of a barrier metal and degradation of the display performance such as the gradation display of the liquid crystals can be prevented. As a result, remarkable improvement in the productivity is possible by the shortening of the tact time by saving the barrier metal film forming step.

The amount of the elements incorporated in the Cu alloy film is suppressed to 3.0 at % or less, more preferably, 2.0 at % or less in total in a case of Zn and/or Mg, and 0.5 at % or less and, more preferably, 0.4 at % or less in total in a case of Ni and/or Mn while taking the lowering of the electrical resistivity by heat treatment also into consideration.

The Cu metal film sometimes generates defects such as grain boundary cracks referred to as voids due to tensile stress caused by a heat treatment in the succeeding step. However, in a case of incorporating one or more of Zn, Ni, Mn, and Mg as described above together with Fe and P or Co and P, they are finely precipitated to the grain boundary as FeP or CoP compound during heat treatment and provide the effect of strengthening the grain boundary to suppress occurrence of voids. Accordingly, in a case of undergoing a thermal hysteresis at a high temperature exceeding 300° C. after film formation, it is preferred to add from 0.02 to 1.0 at % in total of Fe and/or Co, and from 0.005 to 0.5 at % of P.

As the transparent conductive film, while indium tin oxide (ITO) is often used as described above, indium zinc oxide (IZO) may of course be used.

It is also a preferred embodiment of a display device in which a transparent conductive film is stacked to the Cu alloy and used as a tab connection electrode.

### EXAMPLE

The constitution, the function and the effect of the invention are to be described specifically with reference to examples but the invention is no way restricted by the following examples.

### Example

Thin films of specimens were formed each at a thickness of 300 nm by using composite sputtering targets in which chips of alloy elements shown in the following Tables 1 to 13 (size: 5 mm×5 mm×1 mm thickness) were arranged each by a predetermined number to sputtering targets made of pure Cu (size: diameter 101.6 mm×thickness 5 mm) and using a sputtering apparatus (HSM-552, manufactured by Shimazu Seisakusho), by a DC magnetron sputtering method (base pressure: 0.27×10⁻³ Pa or less, Ar gas pressure: 0.27 Pa, Ar gas flow rate: 30 sccm, sputtering power: DC200W, inter-electrode distance: 50.4 mm, substrate temperature: room temperature) on glass substrates (#1737, manufactured by Corning Co, size: 50.8 mm diameter×0.7 mm thickness for the evaluation of electrical resistivity and heat resistance, and 101.6 mm diameter×0.7 mm-thickness for the evaluation of contact resistivity), the specimens including;

Pure Cu (Specimen No. 1),

Cu—Zn alloy (Specimens Nos. 2 to 6),

Cu—Mg alloy (Specimens Nos. 7 to 11),

Cu—Mn alloy (Specimens Nos. 12 to 16),

Cu—Ni alloy (Specimen Nos. 17 to 21),

Cu—Zn—Fe—P alloy (Specimen Nos. 22 to 26),

Cu—Mg—Fe—P alloy (Specimen Nos. 27 to 31),

Cu—Mn—Fe—P alloy (Specimen Nos. 32 to 36),

Cu—Ni—Fe—P alloy (Specimen Nos.37 to 41),

Cu—Zn—Mg alloy (Specimen Nos. 42 to 45),

Cu—Mn—Ni alloy (Specimen Nos. 46 to 49),

Cu—Zn—Co—P alloy (Specimen Nos. 50 to 54),

Cu—Mg—Co—P alloy (Specimen Nos. 55 to 59),

Cu—Mn—Co—P alloy (Specimen Nos. 60 to 64), and

Cu—Ni—Co—P alloy (Specimen Nos. 65 to 69).

Then, the metal compositions of the thin films for evaluation were examined by ICP (inductively coupled plasma) emission spectroscopy or ICP mass spectrometry, and the electrical resistivity, the contact resistivity, and the heat resistance were evaluated by the following method.

Electrical Resistivity

Each thin Cu film formed on a glass substrate (#1737, manufactured by Corning Co, size: 50.8 mm diameter×0.7 mm thickness) was patterned for evaluation of electrical resistivity into 100 μm line width and 10 mm line length by photolithography and wet etching. In this case, a liquid mixture comprising a mixed acid of sulfuric acid: nitric acid: acetic acid=50:10:10 was used as a wet etchant. Then, a heat treatment at 250° C.×30 min or 350° C.×30 min was applied by a vacuum heat treatment apparatus (vacuum degree: 0.27×10⁻³ Pa or less), and the electrical resistivity of each of the specimens was measured by a DC4-probe method at a room temperature before and after the vacuum heat treatment. The electrical resistivity for each of the thin Cu films was measured by the steps described above. The pass/fail judgment for the electrical resistivity was made as “pass” (single circle) for those having electrical resistivity of lower than 5.0 μΩ·cm after the heat treatment at 250° C.×30 min, as “failed” (cross) for those having the electrical resistivity of 5.0 μΩ·cm or more, as “pass” (single circle) for those having electrical resistivity of 4.0 μΩ·cm after the heat treatment at 350° C.×30 min, and as “failed” (cross) for those having electrical resistivity of lower than 4.0 μΩ·cm or more.

Tables 1 and 2 show the electrical resistivity measured after heat treatment at 250° C.×30 min or 350° C.×30 min. As apparent from the tables, the aimed value for the electrical resistivity (5.0 μΩ·cm after heat treatment at 250° C.×30 min or 4.0 μΩ·cm after heat treatment at 350° C.×30 min) was satisfied in a case where the total of Zn and Mg was less than 3.0 at % or in a case where the total of Ni and Mn is less than 0.5 at %. Further, the aimed values of the electrical resistivity (5.0 μΩ·cm after heat treatment at 250° C.×30 min and 4.0 μΩ·cm after heat treatment at 350° C.×30 min) were satisfied in a case where the total content of Fe or Co is 1.0 at % or less and the P content is 0.5 at % or less.

TABLE 1

| | Composition of inter-connection | 250° C.-0.5 h heat treatment | | 350° C.-0.5 h heat treatment | |
|---|---|---|---|---|---|
| | electode film | Electric resistivity | Pass/failure | Electric resistivity | Pass/failure |
| No. | (at %) | (μΩ · cm) | criterion | (μΩ · cm) | criterion |
| 1 | Cu | 2.1 | ◯ | 2.0 | ◯ |
| 2 | Cu—0.05Zn | 2.0 | ◯ | 2.0 | ◯ |
| 3 | Cu—0.12Zn | 2.2 | ◯ | 2.1 | ◯ |
| 4 | Cu—2.1Zn | 3.0 | ◯ | 2.9 | ◯ |
| 5 | Cu—3.0Zn | 3.5 | ◯ | 3.4 | ◯ |
| 6 | Cu—4.0Zn | 3.9 | ◯ | 4.2 | X |
| 7 | Cu—0.05Mg | 2.1 | ◯ | 2.0 | ◯ |
| 8 | Cu—0.15Mg | 2.2 | ◯ | 2.1 | ◯ |
| 9 | Cu—1.3Mg | 2.6 | ◯ | 2.5 | ◯ |
| 10 | Cu—3.0Mg | 3.3 | ◯ | 3.2 | ◯ |
| 11 | Cu—4.7Mg | 4.0 | ◯ | 4.3 | X |
| 12 | Cu—0.06Mn | 2.2 | ◯ | 2.1 | ◯ |
| 13 | Cu—0.13Mn | 2.4 | ◯ | 2.3 | ◯ |
| 14 | Cu—0.3Mn | 2.7 | ◯ | 2.6 | ◯ |
| 15 | Cu—0.5Mn | 3.2 | ◯ | 3.1 | ◯ |
| 16 | Cu—0.9Mn | 4.0 | ◯ | 4.3 | X |
| 17 | Cu—0.05Ni | 2.2 | ◯ | 2.1 | ◯ |
| 18 | Cu—0.13Ni | 2.4 | ◯ | 2.3 | ◯ |
| 19 | Cu—0.3Ni | 2.8 | ◯ | 2.7 | ◯ |
| 20 | Cu—0.5Ni | 3.2 | ◯ | 3.1 | ◯ |
| 21 | Cu—0.9Ni | 4.1 | ◯ | 4.2 | X |
| 22 | Cu—2.1Zn—0.01Fe—0.003P | 3.1 | ◯ | 3.0 | ◯ |
| 23 | Cu—2.1Zn—0.023Fe—0.005P | 3.1 | ◯ | 3.0 | ◯ |
| 24 | Cu—2.1Zn—0.1Fe—0.05P | 3.1 | ◯ | 3.0 | ◯ |
| 25 | Cu—2.1Zn—0.9Fe—0.5P | 3.8 | ◯ | 3.8 | ◯ |
| 26 | Cu—2.1Zn—1.2Fe—0.7P | 4.7 | ◯ | 4.1 | X |
| 27 | Cu—2.1Mg—0.01Fe—0.003P | 3.3 | ◯ | 3.2 | ◯ |
| 28 | Cu—2.1Mg—0.023Fe—0.005P | 3.3 | ◯ | 3.2 | ◯ |
| 29 | Cu—2.1Mg—0.1Fe—0.05P | 3.4 | ◯ | 3.3 | ◯ |
| 30 | Cu—2.1Mg—0.9Fe—0.4P | 4.5 | ◯ | 3.9 | ◯ |
| 31 | Cu—2.1Mg—1.2Fe—0.7P | 5.2 | X | 4.3 | X |
| 32 | Cu—0.5Mn—0.01Fe—0.005P | 3.2 | ◯ | 3.2 | ◯ |
| 33 | Cu—0.5Mn—0.025Fe—0.01P | 3.2 | ◯ | 3.2 | ◯ |
| 34 | Cu—0.5Mn—0.1Fe—0.05P | 3.3 | ◯ | 3.3 | ◯ |
| 35 | Cu—0.5Mn—0.9Fe—0.4P | 4.4 | ◯ | 3.9 | ◯ |
| 36 | Cu—0.5Mn—1.2Fe—0.6P | 4.9 | ◯ | 4.3 | X |

TABLE 2

| | Composition of inter-connection | 250° C.-0.5 h heat treatment | | 350° C.-0.5 h heat treatment | |
|---|---|---|---|---|---|
| | electrode film | Electric resistivity | Pass/failure | electric resistivity | Pass/failure |
| No. | (at %) | (μΩ · cm) | criterion | (μΩ · cm) | criterion |
| 37 | Cu—0.5Ni—0.01Fe—0.005P | 3.2 | ◯ | 3.1 | ◯ |
| 38 | Cu—0.5Ni—0.025Fe—0.01P | 3.3 | ◯ | 3.1 | ◯ |
| 39 | Cu—0.5Ni—0.1Fe—0.05P | 3.4 | ◯ | 3.2 | ◯ |
| 40 | Cu—0.5Ni—0.9Fe—0.4P | 4.4 | ◯ | 3.8 | ◯ |
| 41 | Cu—0.5Ni—1.2Fe—0.7P | 5.1 | X | 4.3 | X |
| 42 | Cu—0.03Zn—0.05Mg | 2.1 | ◯ | 2.0 | ◯ |
| 43 | Cu—0.5Zn—2.3Mg | 3.2 | ◯ | 3.1 | ◯ |
| 44 | Cu—1.5Zn—1.0Mg | 3.2 | ◯ | 3.1 | ◯ |
| 45 | Cu—3.2Zn—2.3Mg | 4.5 | ◯ | 4.4 | X |
| 46 | Cu—0.03Mn—0.04Ni | 2.3 | ◯ | 2.2 | ◯ |
| 47 | Cu—0.1Mn—0.1Ni | 2.5 | ◯ | 2.4 | ◯ |
| 48 | Cu—0.2Mn—0.2Ni | 3.0 | ◯ | 2.9 | ◯ |
| 49 | Cu—0.6Mn—0.6Ni | 4.7 | ◯ | 4.6 | X |
| 50 | Cu—2.1Zn—0.01Co—0.005P | 3.1 | ◯ | 3.0 | ◯ |
| 51 | Cu—2.1Zn—0.025Co—0.01P | 3.1 | ◯ | 3.0 | ◯ |
| 52 | Cu—2.1Zn—0.1Co—0.05P | 3.2 | ◯ | 3.0 | ◯ |
| 53 | Cu—2.1Zn—0.9Co—0.5P | 4.5 | ◯ | 3.8 | ◯ |
| 54 | Cu—2.1Zn—1.4Co—0.6P | 5.1 | X | 4.1 | X |
| 55 | Cu—2.1Mg—0.01Co—0.005P | 3.3 | ◯ | 3.2 | ◯ |
| 56 | Cu—2.1Mg—0.025Co—0.01P | 3.3 | ◯ | 3.2 | ◯ |
| 57 | Cu—2.1Mg—0.1Co—0.05P | 3.5 | ◯ | 3.3 | ◯ |
| 58 | Cu—2.1Mg—0.9Co—0.4P | 4.6 | ◯ | 3.9 | ◯ |
| 59 | Cu—2.1Mg—1.2Co—0.7P | 5.3 | X | 4.3 | X |
| 60 | Cu—0.5Mn—0.01Co—0.005P | 3.2 | ◯ | 3.1 | ◯ |
| 61 | Cu—0.5Mn—0.025Co—0.01P | 3.2 | ◯ | 3.1 | ◯ |
| 62 | Cu—0.5Mn—0.1Co—0.05P | 3.3 | ◯ | 3.2 | ◯ |
| 63 | Cu—0.5Mn—0.8Co—0.4P | 4.4 | ◯ | 3.8 | ◯ |
| 64 | Cu—0.5Mn—1.3Co—0.6P | 5.1 | X | 4.2 | X |
| 65 | Cu—0.5Ni—0.01Co—0.005P | 3.2 | ◯ | 3.1 | ◯ |
| 66 | Cu—0.5Ni—0.025Co—0.01P | 3.3 | ◯ | 3.1 | ◯ |
| 67 | Cu—0.5Ni—0.1Co—0.05P | 3.4 | ◯ | 3.2 | ◯ |
| 68 | Cu—0.5Ni—0.9Co—0.5P | 4.6 | ◯ | 3.9 | ◯ |
| 69 | Cu—0.5Ni—1.3Co—0.7P | 5.3 | X | 4.3 | X |

[Contact Resistivity—Dry Etching Process]

For examining the dependence of the contact resistivity on the etching process, contact resistivity was measured for contact holes formed by a dry etching process. Details for the process of forming the contacts are as described below.

A thin SiN film was formed to a 300 nm thickness by a plasma CVD apparatus for each thin Cu film formed on a glass substrate. The substrate heating temperature was set to 250° C. or 350° C., and the net heat treatment time also including the preliminary heating for the glass substrate and the CVD treatment was set to 0.5 hours.

Then, photolithography for the contact hole was conducted and a contact hole (10×10 μm square: 1) was formed to SiN by dry etching using an ICP type dry etcher. Then, the resist was removed by oxygen ashing and dipping in a non-amine resist stripping solution, and the bottom surface of the contact was washed with a buffered hydrofluoric acid. Then, an ITO film was formed by a DC magnetron sputtering method, and the thin ITO film was fabricated into a Kelvin pattern of 100 μm line width and 400 μm line length. In this case, an ITO etching solution manufactured by Nagase Chemtex Co. was used as a wet etchant. The resistivity was measured by a 4-probe method, and the contact resistance value was measured based on the voltage dropping-component at the contact portion of the Cu/ITO boundary, and the contact resistivity per unit area was calculated based on the known contact hole area and the contact resistance value.

With the steps described above, a Kelvin pattern capable of measuring the contact resistance between each of the thin Cu films and the thin ITO films was manufactured to measure the contact resistance. For the pass/failure judgment of the contact resistance, those showing an average contact resistivity of less than 5×10⁻⁴ Ω·cm² for 90 points in total excluding 5 points for the maximum value and 5points for the minimum value among 100 points of the measurement were evaluated as “pass” (single circle) and those showing larger values than described above were evaluated as “failed” (cross). Further, for the evaluation of scattering, those in which the ratio showing the contact resistivity exceeding 5×10⁻⁴ Ω·cm² (failure rate) was less than 10% among the result of measurements for 100 points were evaluated as “pass” (single circle ) and those in which the ratio was 10% or more were evaluated as “failed” (cross). CVD film formation and heat treatment were conducted at 250° C. or 350° C., and the results of evaluation for the contact resistivity of the specimens formed with contact holes by the dry process are shown in the following Tables 3 to 5 and Tables 6 to 8. As can be seen from Tables 3 to 8, the pass criterion of the average contact resistivity is satisfied for any of pure Cu and Cu alloy. However, a Cu—(Zn, Ni, Mn, Mg) alloy film and a Cu—(Zn, Ni, Mn, Mg)—(Fe, Co)—P alloy film with the total content of one or more of elements selected from Zn, Ni, Mn, and Mg of 0.1 at % or more show less scattering for the contact resistivity and highly reliable low-contact resistivity is obtained when compared with pure Cu.

[Contact Resistivity—Wet Etching Process]

For examining the dependence of the contact resistivity on the etching process, contact resistivity was measured for contact holes formed by the wet etching process. Details for the process of forming the contacts are as described below.

A thin SiN film was formed to a 300 nm thickness by a plasma CVD apparatus for each Cu film formed on a glass substrate. The substrate heating temperature was set to 250° C. or 350° C., and the net heat treatment time also including the preliminary heating for the glass substrate and the CVD treatment was set to 0.5 hours. Then, photolithography was conducted for the contact hole and the contact hole (10×10 μm squre: 1) was formed to SiN by wet etching. A buffered hydrofluoric acid is used for wet etching. Then, an ITO film was formed by a DC magnetron sputtering method, and the thin ITO film was fabricated by photolithography and wet etching into a Kelvin pattern of 100 μm line width and 400 μm line length, to evaluate the contact resistance value. In this case, an ITO etching solution manufactured by Nagase Chemtex Co. was used for the wet etchant. The resistivity was measured by a 4-probe method using a pattern of an identical shape, the contact resistance value was measured based on the voltage dropping component for the contact portion at the Cu/ITO boundary, and the contact resistivity per unit area was calculated based on the known contact hole area and the contact resistance value.

With the steps described above, a Kelvin pattern capable of measuring the contact resistance between each of the thin Cu films and the thin ITO films was prepared to measure the contact resistance. For the pass/failure judgment of the contact resistance, those showing an average contact resistivity of less than 5×10⁻⁴ Ω·cm² for 90 points in total excluding 5 points for the maximum value and 5 points for the minimum value among 100 points of the measurement were evaluated as “pass” (single circle) and those showing larger values than described above were evaluated as “failed” (cross). Further, for the evaluation of scattering, those in which the ratio showing the contact resistivity exceeding 5×10⁻⁴ Ω·cm² (failure rate) was less than 10% among the result of measurements for 100 points were evaluated as “pass” (single circle) and those in which the ratio was 10% or more were evaluated as “failed” (cross).

CVD film formation and heat treatment were conducted at 250° C. or 350° C., and the results of evaluation for the contact resistivity of the specimens formed with contact holes by the dry process are shown in the following Tables 3 to 5 and Tables 6 to 8. As can be seen from the tables, the pass criterion of the average contact resistivity is satisfied for any of pure Cu and Cu alloy. However, a Cu—(Zn, Ni, Mn, Mg) alloy film and a Cu—(Zn, Ni, Mn, Mg)—(Fe, Co)—P alloy film with the total content of one or more of elements selected from Zn, Ni, Mn, and Mg is 0.1 at % or more show less scattering for the contact resistivity and highly reliable low contact resistivity is obtained when compared with pure Cu.

[Contact Resistivity—Contact Reliability Test] After forming the contacts by the same method as described above by wet etching, a contact reliability test was conducted by positively applying oxygen ashing. This simulates atmospheric oxidation when Cu and Cu alloy films are stored in an atmospheric air and details for the process forming the contact are as described below.

For each thin Cu film formed on a glass substrate, photolithography and wet etching were applied to conduct inter connection fabrication. As the wet etchant, a mixed acid comprising sulfuric acid:nitric acid:acetic acid=50:10:10 was used. Then, a thin SiN film was formed at a thickness of 300 nm by a plasma CVD apparatus. The substrate heating temperature was set to 250° C. or 350° C. and the net heat treatment time also including the preliminary heating for the glass substrate and CVD treatment was set to 0.5 hours.

Then, photolithography to the contact hole was applied and contact etching for SiN was conducted by wet etching. As the wet etching, a buffered hydrofluoric acid was used. Then, an ashing treatment was conducted in an oxygen atmosphere by using an ashing apparatus to oxidize the contact bottom face. Then, for the specimens described above, ITO films were formed each to a thickness of 100 nm and then photolithography and wet etching were applied and the dependence of the contact resistance value on the ashing time was evaluated. The resistivity was measured by a 4-probe method using a pattern of an identical shape for 100 points, the contact resistance value was measured based on the voltage dropping component for the contact portion at the Cu/ITO boundary and the contact resistivity per unit area was calculated based on the known contact hole area and the contact resistance value.

With the steps described above, a Kelvin pattern capable of measuring the contact resistance between each of the thin Cu films and the thin ITO films was prepared to measure the contact resistance. For the pass/failure judgment of the contact resistance, those showing an average contact resistivity of less than 5×10⁻⁴ Ω·cm² for 90 points in total excluding the 5 points for the maximum value and 5 points for the minimum value among 100 points of the measurement were evaluated as “pass” (single circle) and those showing larger values than those described above were evaluated as “failed” (cross). Further, for the evaluation of scattering, those in which the ratio showing the contact resistivity exceeding 5×10⁻⁴ Ω·cm² (failure rate) was less than 10% among the result of measurements for 100 points were evaluated as “pass” (single circle) and those in which the ratio was 10% or more were evaluated as “failed” (cross).

CVD film formation and heat treatment were conducted at 250° C. or 350° C., and the result of evaluation for the contact resistivity of specimens applied with an ashing treatment for 10 min after forming contact holes by a wet process are shown in the following Tables 3 to 8. As can be seen from Tables 3 to 8, pure Cu shows high contact resistivity and great scattering. On the other hand, a Cu—(Zn, Ni, Mn, Mg) alloy film, and a Cu—(Zn, Ni, Mn, Mg)—(Fe, Co)—P alloy film with the total content of one or more of elements selected from Zn, Ni, Mn, and Mg of 0.1 at % or more showed lower average contact resistivity and less scattering compared with pure Cu, to attain favorable contact. This shows that use of the Cu alloy cause less suffering from atmospheric oxidation and improves the process-margin during manufacturing steps.

TABLE 3
250° C. × 30 min heat treatment

| | | Dry etching | | | | Wet etching | | | | Wet etching + oxygen ashing (10 min) | | | |
|---|---|---|---|---|---|---|---|---|---|---|---|---|---|
| | | Average | | | | Average | | | | Average | | | |
| | Composition | contact | | | | contact | | | | contact | | | |
| | of inter-connection | resistivity | | | | resistivity | | | | resistivity | | | |
| | electrode film | (×10⁻⁵ | Pass/fail | Failure | Pass/fail | (×10⁻⁵ | Pass/fail | Failure | Pass/fail | (×10⁻⁵ | Pass/fail | Failure | Pass/fail |
| No. | (at %) | Ω · cm) | criterion | rate(%) | criterion | Ω ·cm) | criterion | rate(%) | criterion | Ω · cm) | criterion | rate(%) | criterion |
| 1 | Cu | 48 | ◯ | 34 | X | 5 | ◯ | 8 | ◯ | 128 | X | 90 | X |
| 2 | Cu—0.05Zn | 43 | ◯ | 12 | X | 5 | ◯ | 2 | ◯ | 56 | X | 12 | X |
| 3 | Cu—0.12Zn | 36 | ◯ | 8 | ◯ | 4 | ◯ | 0 | ◯ | 43 | ◯ | 9 | ◯ |
| 4 | Cu—2.1Zn | 30 | ◯ | 6 | ◯ | 4 | ◯ | 0 | ◯ | 24 | ◯ | 5 | ◯ |
| 5 | Cu—3.0Zn | 25 | ◯ | 5 | ◯ | 3 | ◯ | 0 | ◯ | 21 | ◯ | 4 | ◯ |
| 6 | Cu—4.0Zn | 22 | ◯ | 5 | ◯ | 3 | ◯ | 0 | ◯ | 18 | ◯ | 4 | ◯ |
| 7 | Cu—0.05Mg | 45 | ◯ | 14 | X | 4 | ◯ | 2 | ◯ | 56 | X | 14 | X |
| 8 | Cu—0.15Mg | 39 | ◯ | 8 | ◯ | 4 | ◯ | 0 | ◯ | 36 | ◯ | 8 | ◯ |
| 9 | Cu—1.3Mg | 35 | ◯ | 7 | ◯ | 4 | ◯ | 0 | ◯ | 27 | ◯ | 6 | ◯ |
| 10 | Cu—3.0Mg | 28 | ◯ | 7 | ◯ | 3 | ◯ | 0 | ◯ | 25 | ◯ | 7 | ◯ |
| 11 | Cu—4.7Mg | 26 | ◯ | 5 | ◯ | 4 | ◯ | 0 | ◯ | 23 | ◯ | 5 | ◯ |
| 12 | Cu—0.06Mn | 46 | ◯ | 15 | X | 4 | ◯ | 3 | ◯ | 61 | X | 15 | X |
| 13 | Cu—0.13Mn | 40 | ◯ | 8 | ◯ | 4 | ◯ | 1 | ◯ | 47 | ◯ | 9 | ◯ |
| 14 | Cu—0.3Mn | 34 | ◯ | 6 | ◯ | 4 | ◯ | 0 | ◯ | 43 | ◯ | 6 | ◯ |
| 15 | Cu—0.5Mn | 34 | ◯ | 6 | ◯ | 3 | ◯ | 0 | ◯ | 40 | ◯ | 6 | ◯ |
| 16 | Cu—0.9Mn | 31 | ◯ | 5 | ◯ | 3 | ◯ | 0 | ◯ | 38 | ◯ | 5 | ◯ |
| 17 | Cu—0.05Ni | 42 | ◯ | 12 | X | 4 | ◯ | 2 | ◯ | 53 | X | 12 | X |
| 18 | Cu—0.13Ni | 29 | ◯ | 6 | ◯ | 4 | ◯ | 0 | ◯ | 13 | ◯ | 3 | ◯ |
| 19 | Cu—0.3Ni | 25 | ◯ | 5 | ◯ | 4 | ◯ | 0 | ◯ | 9 | ◯ | 2 | ◯ |
| 20 | Cu—0.5Ni | 23 | ◯ | 5 | ◯ | 3 | ◯ | 0 | ◯ | 8 | ◯ | 2 | ◯ |
| 21 | Cu—0.9Ni | 20 | ◯ | 4 | ◯ | 3 | ◯ | 0 | ◯ | 6 | ◯ | 1 | ◯ |

TABLE 4
After 250° C. × 30 min heat treatment

| | Composition of inter-connection | Dry etching | | | | Wet etching |
|---|---|---|---|---|---|---|
| | electrode film | Average contact resistivity | Pass/fail | Failure | Pass/Fail | Average contact resistivity |
| No. | (at %) | (×10⁻⁵ Ω · cm) | criterion | rate(%) | criterion | (×10⁻⁵ Ω · cm) |
| 22 | Cu—2.1Zn—0.01Fe—0.003P | 29 | ◯ | 6 | ◯ | 4 |
| 23 | Cu—2.1Zn—0.023Fe—0.005P | 29 | ◯ | 6 | ◯ | 3 |
| 24 | Cu—2.1Zn—0.1Fe—0.05P | 31 | ◯ | 7 | ◯ | 3 |
| 25 | Cu—2.1Zn—0.9Fe—0.5P | 30 | ◯ | 6 | ◯ | 4 |
| 26 | Cu—2.1Zn—1.2Fe—0.7P | 28 | ◯ | 6 | ◯ | 3 |
| 27 | Cu—2.1Mg—0.01Fe—0.003P | 32 | ◯ | 7 | ◯ | 4 |
| 28 | Cu—2.1Mg—0.023Fe—0.005P | 35 | ◯ | 7 | ◯ | 3 |
| 29 | Cu—2.1Mg—0.1Fe—0.05P | 30 | ◯ | 6 | ◯ | 4 |
| 30 | Cu—2.1Mg—0.9Fe—0.4P | 32 | ◯ | 7 | ◯ | 4 |
| 31 | Cu—2.1Mg—1.2Fe—0.7P | 33 | ◯ | 7 | ◯ | 3 |
| 32 | Cu—0.5Mn—0.01Fe—0.005P | 34 | ◯ | 7 | ◯ | 3 |
| 33 | Cu—0.5Mn—0.025Fe—0.01P | 34 | ◯ | 7 | ◯ | 4 |
| 34 | Cu—0.5Mn—0.1Fe—0.05P | 36 | ◯ | 8 | ◯ | 3 |
| 35 | Cu—0.5Mn—0.9Fe—0.4P | 33 | ◯ | 7 | ◯ | 3 |
| 36 | Cu—0.5Mn—1.2Fe—0.6P | 35 | ◯ | 7 | ◯ | 3 |
| 37 | Cu—0.5Ni—0.01Fe—0.005P | 24 | ◯ | 5 | ◯ | 3 |
| 38 | Cu—0.5Ni—0.025Fe—0.01P | 21 | ◯ | 4 | ◯ | 3 |
| 39 | Cu—0.5Ni—0.1Fe—0.05P | 25 | ◯ | 5 | ◯ | 3 |
| 40 | Cu—0.5Ni—0.9Fe—0.4P | 23 | ◯ | 5 | ◯ | 3 |
| 41 | Cu—0.5Ni—1.2Fe—0.7P | 22 | ◯ | 5 | ◯ | 3 |
| 42 | Cu—0.03Zn—0.05Mg | 46 | ◯ | 11 | X | 4 |
| 43 | Cu—0.5Zn—2.3Mg | 28 | ◯ | 6 | ◯ | 4 |
| 44 | Cu—1.5Zn—1.0Mg | 32 | ◯ | 7 | ◯ | 4 |
| 45 | Cu—3.2Zn—2.3Mg | 24 | ◯ | 4 | ◯ | 3 |
| 46 | Cu—0.03Mn—0.04Ni | 47 | ◯ | 13 | X | 4 |
| 47 | Cu—0.1Mn—0.1Ni | 37 | ◯ | 8 | ◯ | 4 |
| 48 | Cu—0.2Mn—0.2Ni | 25 | ◯ | 5 | ◯ | 3 |
| 49 | Cu—0.6Mn—0.6Ni | 21 | ◯ | 4 | ◯ | 3 |

| | Wet etching | | | Wet etching + oxygen ashing (10 min) | | | |
|---|---|---|---|---|---|---|---|
| | Pass/fail | Failure | Pass/fail | Avarage contact resistivity | Pass/fail | Failure | Pass/fail |
| No. | criterion | rate(%) | criterion | (×10⁻⁵ Ω · cm) | criterion | rate(%) | criterion |
| 22 | ◯ | 0 | ◯ | 23 | ◯ | 5 | ◯ |
| 23 | ◯ | 0 | ◯ | 24 | ◯ | 5 | ◯ |
| 24 | ◯ | 0 | ◯ | 23 | ◯ | 5 | ◯ |
| 25 | ◯ | 0 | ◯ | 22 | ◯ | 5 | ◯ |
| 26 | ◯ | 0 | ◯ | 23 | ◯ | 5 | ◯ |
| 27 | ◯ | 0 | ◯ | 25 | ◯ | 5 | ◯ |
| 28 | ◯ | 0 | ◯ | 24 | ◯ | 5 | ◯ |
| 29 | ◯ | 0 | ◯ | 27 | ◯ | 6 | ◯ |
| 30 | ◯ | 0 | ◯ | 26 | ◯ | 5 | ◯ |
| 31 | ◯ | 0 | ◯ | 26 | ◯ | 5 | ◯ |
| 32 | ◯ | 0 | ◯ | 43 | ◯ | 9 | ◯ |
| 33 | ◯ | 0 | ◯ | 29 | ◯ | 8 | ◯ |
| 34 | ◯ | 0 | ◯ | 29 | ◯ | 8 | ◯ |
| 35 | ◯ | 0 | ◯ | 42 | ◯ | 9 | ◯ |
| 36 | ◯ | 0 | ◯ | 40 | ◯ | 8 | ◯ |
| 37 | ◯ | 0 | ◯ | 8 | ◯ | 2 | ◯ |
| 38 | ◯ | 0 | ◯ | 7 | ◯ | 1 | ◯ |
| 39 | ◯ | 0 | ◯ | 9 | ◯ | 2 | ◯ |
| 40 | ◯ | 0 | ◯ | 8 | ◯ | 2 | ◯ |
| 41 | ◯ | 0 | ◯ | 8 | ◯ | 2 | ◯ |
| 42 | ◯ | 2 | ◯ | 53 | X | 11 | X |
| 43 | ◯ | 1 | ◯ | 24 | ◯ | 6 | ◯ |
| 44 | ◯ | 0 | ◯ | 20 | ◯ | 7 | ◯ |
| 45 | ◯ | 0 | ◯ | 10 | ◯ | 4 | ◯ |
| 46 | ◯ | 2 | ◯ | 52 | X | 13 | X |
| 47 | ◯ | 0 | ◯ | 13 | ◯ | 8 | ◯ |
| 48 | ◯ | 0 | ◯ | 9 | ◯ | 5 | ◯ |
| 49 | ◯ | 0 | ◯ | 5 | ◯ | 4 | ◯ |

TABLE 5
After 250° C. × 30 min heat treatment

| | Composition of inter-connection | Dry etching | | | | Wet etching |
|---|---|---|---|---|---|---|
| | electrode film | Average contact resistivity | Pass/fail | Failure | Pass/fail | Average contact resistivity |
| No. | (at %) | (×10⁻⁵ Ω · cm) | criterion | rate(%) | criterion | (×10⁻⁵ Ω · cm) |
| 50 | Cu—2.1Zn—0.01Co—0.005P | 28 | ◯ | 6 | ◯ | 4 |
| 51 | Cu—2.1Zn—0.025Co—0.01P | 26 | ◯ | 5 | ◯ | 3 |
| 52 | Cu—2.1Zn—0.1Co—0.05P | 29 | ◯ | 6 | ◯ | 4 |
| 53 | Cu—2.1Zn—0.9Co—0.5P | 27 | ◯ | 6 | ◯ | 4 |
| 54 | Cu—2.1Zn—1.4Co—0.6P | 25 | ◯ | 5 | ◯ | 4 |
| 55 | Cu—2.1Mg—0.01Co—0.005P | 26 | ◯ | 5 | ◯ | 4 |
| 56 | Cu—2.1Mg—0.025Co—0.01P | 27 | ◯ | 6 | ◯ | 3 |
| 57 | Cu—2.1Mg—0.1Co—0.05P | 26 | ◯ | 5 | ◯ | 4 |
| 58 | Cu—2.1Mg—0.9Co—0.4P | 29 | ◯ | 6 | ◯ | 4 |
| 59 | Cu—2.1Mg—1.2Co—0.7P | 25 | ◯ | 5 | ◯ | 4 |
| 60 | Cu—0.5Mn—0.01Co—0.005P | 40 | ◯ | 8 | ◯ | 3 |
| 61 | Cu—0.5Mn—0.025Co—0.01P | 39 | ◯ | 8 | ◯ | 3 |
| 62 | Cu—0.5Mn—0.1Co—0.05P | 41 | ◯ | 9 | ◯ | 3 |
| 63 | Cu—0.5Mn—0.8Co—0.4P | 38 | ◯ | 8 | ◯ | 4 |
| 64 | Cu—0.5Mn—1.3Co—0.6P | 40 | ◯ | 8 | ◯ | 3 |
| 65 | Cu—0.5Ni—0.01Co—0.005P | 24 | ◯ | 5 | ◯ | 3 |
| 66 | Cu—0.5Ni—0.025Co—0.01P | 22 | ◯ | 5 | ◯ | 4 |
| 67 | Cu—0.5Ni—0.1Co—0.05P | 25 | ◯ | 5 | ◯ | 3 |
| 68 | Cu—0.5Ni—0.9Co—0.5P | 21 | ◯ | 4 | ◯ | 3 |
| 69 | Cu—0.5Ni—1.3Co—0.7P | 24 | ◯ | 5 | ◯ | 3 |

| | Wet etching | | | Wet etching + oxygen ashing (10 min) | | | |
|---|---|---|---|---|---|---|---|
| | Pass/fail | Failure | Pass/fail | Avarage contact resistivity | Pass/fail | Failure | Pass/fail |
| No. | criterion | rate(%) | criterion | (×10⁻⁵ Ω · cm) | criterion | rate(%) | criterion |
| 50 | ◯ | 0 | ◯ | 25 | ◯ | 5 | ◯ |
| 51 | ◯ | 0 | ◯ | 23 | ◯ | 5 | ◯ |
| 52 | ◯ | 0 | ◯ | 24 | ◯ | 5 | ◯ |
| 53 | ◯ | 0 | ◯ | 24 | ◯ | 5 | ◯ |
| 54 | ◯ | 0 | ◯ | 23 | ◯ | 5 | ◯ |
| 55 | ◯ | 0 | ◯ | 26 | ◯ | 5 | ◯ |
| 56 | ◯ | 0 | ◯ | 27 | ◯ | 6 | ◯ |
| 57 | ◯ | 0 | ◯ | 25 | ◯ | 5 | ◯ |
| 58 | ◯ | 0 | ◯ | 28 | ◯ | 6 | ◯ |
| 59 | ◯ | 0 | ◯ | 27 | ◯ | 6 | ◯ |
| 60 | ◯ | 0 | ◯ | 40 | ◯ | 8 | ◯ |
| 61 | ◯ | 0 | ◯ | 39 | ◯ | 8 | ◯ |
| 62 | ◯ | 0 | ◯ | 41 | ◯ | 9 | ◯ |
| 63 | ◯ | 0 | ◯ | 38 | ◯ | 8 | ◯ |
| 64 | ◯ | 0 | ◯ | 40 | ◯ | 8 | ◯ |
| 65 | ◯ | 0 | ◯ | 7 | ◯ | 1 | ◯ |
| 66 | ◯ | 0 | ◯ | 9 | ◯ | 2 | ◯ |
| 67 | ◯ | 0 | ◯ | 8 | ◯ | 2 | ◯ |
| 68 | ◯ | 0 | ◯ | 8 | ◯ | 2 | ◯ |
| 69 | ◯ | 0 | ◯ | 9 | ◯ | 2 | ◯ |

TABLE 6
After 350° C. × 30 min heat treatment

| | | Dry etching | | | | Wet etching | | | | Wet etching + oxygen ashing (10 min) | | | |
|---|---|---|---|---|---|---|---|---|---|---|---|---|---|
| | | Average | | | | Average | | | | Average | | | |
| | Composition | contact | | | | contact | | | | contact | | | |
| | of inter-connection | resistivity | | | | resistivity | | | | resistivity | | | |
| | electrode film | (×10⁻⁵ | Pass/fail | Failure | Pass/fail | (× 10⁻⁵ | Pass/fail | Failure | Pass/fail | (× 10⁻⁵ | Pass/fail | Failure | Pass/fail |
| No. | (at %) | Ω · cm) | criterion | rate(%) | criterion | Ω · cm) | criterion | rate(%) | criterion | Ω · cm) | criterion | rate(%) | criterion |
| 1 | Cu | 46 | ◯ | 32 | X | 5 | ◯ | 9 | ◯ | 131 | X | 95 | X |
| 2 | Cu—0.05Zn | 41 | ◯ | 12 | X | 4 | ◯ | 2 | ◯ | 53 | X | 14 | X |
| 3 | Cu—0.12Zn | 34 | ◯ | 7 | ◯ | 4 | ◯ | 0 | ◯ | 41 | ◯ | 9 | ◯ |
| 4 | Cu—2.1Zn | 29 | ◯ | 6 | ◯ | 4 | ◯ | 0 | ◯ | 22 | ◯ | 5 | ◯ |
| 5 | Cu—3.0Zn | 24 | ◯ | 5 | ◯ | 3 | ◯ | 0 | ◯ | 20 | ◯ | 4 | ◯ |
| 6 | Cu—4.0Zn | 21 | ◯ | 4 | ◯ | 3 | ◯ | 0 | ◯ | 17 | ◯ | 4 | ◯ |
| 7 | Cu—0.05Mg | 43 | ◯ | 14 | X | 4 | ◯ | 3 | ◯ | 53 | X | 15 | X |
| 8 | Cu—0.15Mg | 37 | ◯ | 8 | ◯ | 4 | ◯ | 0 | ◯ | 34 | ◯ | 8 | ◯ |
| 9 | Cu—1.3Mg | 33 | ◯ | 7 | ◯ | 4 | ◯ | 0 | ◯ | 26 | ◯ | 5 | ◯ |
| 10 | Cu—3.0Mg | 27 | ◯ | 7 | ◯ | 3 | ◯ | 0 | ◯ | 24 | ◯ | 7 | ◯ |
| 11 | Cu—4.7Mg | 25 | ◯ | 5 | ◯ | 4 | ◯ | 0 | ◯ | 22 | ◯ | 5 | ◯ |
| 12 | Cu—0.06Mn | 44 | ◯ | 15 | X | 4 | ◯ | 4 | ◯ | 58 | X | 18 | X |
| 13 | Cu—0.13Mn | 38 | ◯ | 8 | ◯ | 4 | ◯ | 1 | ◯ | 45 | ◯ | 9 | ◯ |
| 14 | Cu—0.3Mn | 32 | ◯ | 6 | ◯ | 3 | ◯ | 0 | ◯ | 41 | ◯ | 6 | ◯ |
| 15 | Cu—0.5Mn | 32 | ◯ | 6 | ◯ | 3 | ◯ | 0 | ◯ | 38 | ◯ | 5 | ◯ |
| 16 | Cu—0.9Mn | 29 | ◯ | 5 | ◯ | 3 | ◯ | 0 | ◯ | 36 | ◯ | 4 | ◯ |
| 17 | Cu—0.05Ni | 40 | ◯ | 12 | X | 3 | ◯ | 2 | ◯ | 51 | X | 11 | X |
| 18 | Cu—0.13Ni | 28 | ◯ | 6 | ◯ | 4 | ◯ | 0 | ◯ | 13 | ◯ | 3 | ◯ |
| 19 | Cu—0.3Ni | 24 | ◯ | 5 | ◯ | 3 | ◯ | 0 | ◯ | 8 | ◯ | 2 | ◯ |
| 20 | Cu—0.5Ni | 22 | ◯ | 5 | ◯ | 3 | ◯ | 0 | ◯ | 7 | ◯ | 2 | ◯ |
| 21 | Cu—0.9Ni | 19 | ◯ | 4 | ◯ | 3 | ◯ | 0 | ◯ | 6 | ◯ | 1 | ◯ |

TABLE 7
After 350° C. × 30 min heat treatment

| | Compostion of inter-connection | Dry etching | | | | Wet etching |
|---|---|---|---|---|---|---|
| | electrode film | Average contact resistivity | Pass/fail | Failure | Pass/fail | Average contact resistivity |
| No. | (at %) | (×10⁻⁵ Ω · cm) | criterion | rate(%) | criterion | (×10⁻⁵ Ω · cm) |
| 22 | Cu—2.1Zn—0.01Fe—0.003P | 28 | ◯ | 6 | ◯ | 4 |
| 23 | Cu—2.1Zn—0.023Fe—0.005P | 28 | ◯ | 6 | ◯ | 3 |
| 24 | Cu—2.1Zn—0.1Fe—0.05P | 29 | ◯ | 6 | ◯ | 3 |
| 25 | Cu—2.1Zn—0.9Fe—0.5P | 29 | ◯ | 6 | ◯ | 4 |
| 26 | Cu—2.1Zn—1.2Fe—0.7P | 27 | ◯ | 6 | ◯ | 3 |
| 27 | Cu—2.1Mg—0.01Fe—0.003P | 30 | ◯ | 6 | ◯ | 4 |
| 28 | Cu—2.1Mg—0.023Fe—0.005P | 33 | ◯ | 7 | ◯ | 3 |
| 29 | Cu—2.1Mg—0.1Fe—0.05P | 29 | ◯ | 6 | ◯ | 4 |
| 30 | Cu—2.1Mg—0.9Fe—0.4P | 30 | ◯ | 6 | ◯ | 4 |
| 31 | Cu—2.1Mg—1.2Fe—0.7P | 31 | ◯ | 7 | ◯ | 3 |
| 32 | Cu—0.5Mn—0.01Fe—0.005P | 32 | ◯ | 7 | ◯ | 3 |
| 33 | Cu—0.5Mn—0.025Fe—0.01P | 32 | ◯ | 7 | ◯ | 3 |
| 34 | Cu—0.5Mn—0.1Fe—0.05P | 34 | ◯ | 7 | ◯ | 3 |
| 35 | Cu—0.5Mn—0.9Fe—0.4P | 31 | ◯ | 7 | ◯ | 3 |
| 36 | Cu—0.5Mn—1.2Fe—0.6P | 33 | ◯ | 7 | ◯ | 3 |
| 37 | Cu—0.5Ni—0.01Fe—0.005P | 23 | ◯ | 5 | ◯ | 3 |
| 38 | Cu—0.5Ni—0.025Fe—0.01P | 20 | ◯ | 4 | ◯ | 3 |
| 39 | Cu—0.5Ni—0.1Fe—0.05P | 24 | ◯ | 5 | ◯ | 3 |
| 40 | Cu—0.5Ni—0.9Fe—0.4P | 22 | ◯ | 5 | ◯ | 3 |
| 41 | Cu—0.5Ni—1.2Fe—0.7P | 21 | ◯ | 4 | ◯ | 3 |
| 42 | Cu—0.03Zn—0.05Mg | 44 | ◯ | 11 | X | 4 |
| 43 | Cu—0.5Zn—2.3Mg | 27 | ◯ | 6 | ◯ | 4 |
| 44 | Cu—1.5Zn—1.0Mg | 30 | ◯ | 7 | ◯ | 4 |
| 45 | Cu—3.2Zn—2.3Mg | 23 | ◯ | 4 | ◯ | 3 |
| 46 | Cu—0.03Mn—0.04Ni | 45 | ◯ | 13 | X | 4 |
| 47 | Cu—0.1Mn—0.1Ni | 35 | ◯ | 8 | ◯ | 4 |
| 48 | Cu—0.2Mn—0.2Ni | 24 | ◯ | 5 | ◯ | 3 |
| 49 | Cu—0.6Mn—0.6Ni | 20 | ◯ | 4 | ◯ | 3 |

| | Wet etching | | | Wet etching + oxygen ashing (10 min) | | | |
|---|---|---|---|---|---|---|---|
| | Pass/fail | Failure | Pass/fail | Average contact resistivity | Pass/fail | Failure | Pass/fail |
| No. | criterion | rate(%) | criterion | (×10⁻⁵ Ω · cm) | criterion | rate(%) | criterion |
| 22 | ◯ | 0 | ◯ | 22 | ◯ | 5 | ◯ |
| 23 | ◯ | 0 | ◯ | 23 | ◯ | 4 | ◯ |
| 24 | ◯ | 0 | ◯ | 22 | ◯ | 4 | ◯ |
| 25 | ◯ | 0 | ◯ | 21 | ◯ | 4 | ◯ |
| 26 | ◯ | 0 | ◯ | 22 | ◯ | 5 | ◯ |
| 27 | ◯ | 0 | ◯ | 24 | ◯ | 4 | ◯ |
| 28 | ◯ | 0 | ◯ | 23 | ◯ | 5 | ◯ |
| 29 | ◯ | 0 | ◯ | 26 | ◯ | 5 | ◯ |
| 30 | ◯ | 0 | ◯ | 25 | ◯ | 4 | ◯ |
| 31 | ◯ | 0 | ◯ | 25 | ◯ | 3 | ◯ |
| 32 | ◯ | 0 | ◯ | 41 | ◯ | 8 | ◯ |
| 33 | ◯ | 0 | ◯ | 37 | ◯ | 8 | ◯ |
| 34 | ◯ | 0 | ◯ | 37 | ◯ | 7 | ◯ |
| 35 | ◯ | 0 | ◯ | 40 | ◯ | 8 | ◯ |
| 36 | ◯ | 0 | ◯ | 38 | ◯ | 7 | ◯ |
| 37 | ◯ | 0 | ◯ | 8 | ◯ | 2 | ◯ |
| 38 | ◯ | 0 | ◯ | 7 | ◯ | 1 | ◯ |
| 39 | ◯ | 0 | ◯ | 9 | ◯ | 2 | ◯ |
| 40 | ◯ | 0 | ◯ | 8 | ◯ | 2 | ◯ |
| 41 | ◯ | 0 | ◯ | 8 | ◯ | 2 | ◯ |
| 42 | ◯ | 1 | ◯ | 50 | X | 12 | X |
| 43 | ◯ | 1 | ◯ | 23 | ◯ | 6 | ◯ |
| 44 | ◯ | 0 | ◯ | 19 | ◯ | 5 | ◯ |
| 45 | ◯ | 0 | ◯ | 10 | ◯ | 3 | ◯ |
| 46 | ◯ | 1 | ◯ | 51 | X | 11 | X |
| 47 | ◯ | 0 | ◯ | 12 | ◯ | 8 | ◯ |
| 48 | ◯ | 0 | ◯ | 9 | ◯ | 4 | ◯ |
| 49 | ◯ | 0 | ◯ | 5 | ◯ | 3 | ◯ |

TABLE 8
After 350° C. × 30 min heat treatment

| | Composition of inter-connection | Dry etching | | | | Wet etching |
|---|---|---|---|---|---|---|
| | electrode film | Average contact resistivity | Pass/fail | Failure | Pass/fail | Average contact resistivity |
| No. | (at %) | (×10⁻⁵ Ω · cm) | criterion | rate(%) | criterion | (×10⁻⁵ Ω · cm) |
| 50 | Cu—2.1Zn—0.01Co—0.005P | 27 | ◯ | 6 | ◯ | 4 |
| 51 | Cu—2.1Zn—0.025Co—0.01P | 25 | ◯ | 5 | ◯ | 3 |
| 52 | Cu—2.1Zn—0.1Co—0.05P | 28 | ◯ | 6 | ◯ | 4 |
| 53 | Cu—2.1Zn—0.9Co—0.5P | 26 | ◯ | 5 | ◯ | 3 |
| 54 | Cu—2.1Zn—1.4Co—0.6P | 24 | ◯ | 5 | ◯ | 4 |
| 55 | Cu—2.1Mg—0.01Co—0.005P | 25 | ◯ | 5 | ◯ | 4 |
| 56 | Cu—2.1Mg—0.025Co—0.01P | 26 | ◯ | 5 | ◯ | 3 |
| 57 | Cu—2.1Mg—0.1Co—0.05P | 25 | ◯ | 5 | ◯ | 4 |
| 58 | Cu—2.1Mg—0.9Co—0.4P | 28 | ◯ | 6 | ◯ | 4 |
| 59 | Cu—2.1Mg—1.2Co—0.7P | 24 | ◯ | 5 | ◯ | 4 |
| 60 | Cu—0.5Mn—0.01Co—0.005P | 38 | ◯ | 8 | ◯ | 3 |
| 61 | Cu—0.5Mn—0.025Co—0.01P | 37 | ◯ | 8 | ◯ | 3 |
| 62 | Cu—0.5Mn—0.1Co—0.05P | 39 | ◯ | 8 | ◯ | 3 |
| 63 | Cu—0.5Mn—0.8Co—0.4P | 36 | ◯ | 8 | ◯ | 3 |
| 64 | Cu—0.5Mn—1.3Co—0.6P | 38 | ◯ | 8 | ◯ | 4 |
| 65 | Cu—0.5Ni—0.01Co—0.005P | 23 | ◯ | 5 | ◯ | 3 |
| 66 | Cu—0.5Ni—0.025Co—0.01P | 21 | ◯ | 4 | ◯ | 3 |
| 67 | Cu—0.5Ni—0.1Co—0.05P | 24 | ◯ | 5 | ◯ | 3 |
| 68 | Cu—0.5Ni—0.9Co—0.5P | 20 | ◯ | 4 | ◯ | 3 |
| 69 | Cu—0.5Ni—1.3Co—0.7P | 23 | ◯ | 5 | ◯ | 3 |

| | Wet etching | | | Wet etching + oxygen ashing (10 min) | | | |
|---|---|---|---|---|---|---|---|
| | Pass/fail | Failure | Pass/fail | Average contact resistivity | Pass/fail | Failure | Pass/fail |
| No. | criterion | rate(%) | criterion | (×10⁻⁵ Ω · cm) | criterion | rate(%) | criterion |
| 50 | ◯ | 0 | ◯ | 24 | ◯ | 5 | ◯ |
| 51 | ◯ | 0 | ◯ | 22 | ◯ | 6 | ◯ |
| 52 | ◯ | 0 | ◯ | 23 | ◯ | 4 | ◯ |
| 53 | ◯ | 0 | ◯ | 23 | ◯ | 5 | ◯ |
| 54 | ◯ | 0 | ◯ | 22 | ◯ | 5 | ◯ |
| 55 | ◯ | 0 | ◯ | 25 | ◯ | 5 | ◯ |
| 56 | ◯ | 0 | ◯ | 26 | ◯ | 4 | ◯ |
| 57 | ◯ | 0 | ◯ | 24 | ◯ | 5 | ◯ |
| 58 | ◯ | 0 | ◯ | 27 | ◯ | 6 | ◯ |
| 59 | ◯ | 0 | ◯ | 26 | ◯ | 5 | ◯ |
| 60 | ◯ | 0 | ◯ | 38 | ◯ | 8 | ◯ |
| 61 | ◯ | 0 | ◯ | 37 | ◯ | 7 | ◯ |
| 62 | ◯ | 0 | ◯ | 39 | ◯ | 8 | ◯ |
| 63 | ◯ | 0 | ◯ | 36 | ◯ | 6 | ◯ |
| 64 | ◯ | 0 | ◯ | 38 | ◯ | 8 | ◯ |
| 65 | ◯ | 0 | ◯ | 7 | ◯ | 1 | ◯ |
| 66 | ◯ | 0 | ◯ | 9 | ◯ | 1 | ◯ |
| 67 | ◯ | 0 | ◯ | 8 | ◯ | 2 | ◯ |
| 68 | ◯ | 0 | ◯ | 8 | ◯ | 2 | ◯ |
| 69 | ◯ | 0 | ◯ | 9 | ◯ | 2 | ◯ |

[Heat Resistance]

Photolithography was conducted by using “AZ P4110” manufactured by Clariant Japan Co. as a photoresist and “AZ developer” manufactured by the same company as a photoresist developing solution (step: photoresist coating→pre-baking→exposure→photoresist development→water rinsing→drying) and wet etching was conducted by using a wet etchant comprising a mixed acid of sulfuric acid:nitric acid:acetic acid=50:10:10 (step: wet etching→water rinsing→drying→photoresist stripping→drying) and each thin Cu film for evaluation was fabricated into a strip pattern of: line width/line pitch=10 μm/10 μm. Then, vacuum heat treatment (vacuum degree: 0.27×10⁻³ Pa or less) at 350° C. for 30 min was applied for each thin Cu film, light etching was conducted to about 10 nm by using a wet etcher on the surface of the specimen after the heat treatment and the heat resistance of each thin Cu film was evaluated.

In the Cu film, concave defects (voids) were formed on the upper surface and the lateral surface of the interconnections when applied with a heat treatment. Then, voids formed by the heat treatment were enhanced by lightly etching the Cu surface after the heat treatment and observed under an optical microscope to measure the void density per unit area. Then, those having a void density of 1.0×10⁻⁸ N/m²or less were evaluated as “excellent” (double circle), those having a void density of 1.0×10⁸ N/m² or more and 1.0×10¹⁰ N/m² or less were evaluated as “good” (single circle) (both (double circle) and (single circle): “pass”), and those having a void density exceeding 1.0×10¹⁰ N/m² were evaluated as “failed” (cross).

The results are as shown in Tables 9 and 10. In a case of applying a heat treatment under vacuum for 350° C.×30 min, the heat resistance was insufficient for pure Cu, whereas Cu—(Zn, Ni, Mn, Mg) alloy films with the total content of one or more of elements selected from Zn, Ni, Mn, and Mg had sufficient heat resistance. Further, it can be seen that Cu—(Zn, Ni, Mn, Mg)—(Fe, Co)—P alloy films containing Fe or Co and P had further excellent heat resistance.

TABLE 9
Heat resistance

| | Composition of inter- | 250° C.-0.5 h | 350° C.-0.5 h |
|---|---|---|---|
| No. | connection electrode(at %) | heat treatment | heat treatment |
| 1 | Cu | ◯ | X |
| 2 | Cu—0.05Zn | ◯ | X |
| 3 | Cu—0.12Zn | ⊚ | ◯ |
| 4 | Cu—2.1Zn | ⊚ | ◯ |
| 5 | Cu—3.0Zn | ⊚ | ◯ |
| 6 | Cu—4.0Zn | ⊚ | ◯ |
| 7 | Cu—0.05Mg | ◯ | X |
| 8 | Cu—0.15Mg | ⊚ | ◯ |
| 9 | Cu—1.3Mg | ⊚ | ◯ |
| 10 | Cu—3.0Mg | ⊚ | ◯ |
| 11 | Cu—4.7Mg | ⊚ | ◯ |
| 12 | Cu—0.06Mn | ◯ | X |
| 13 | Cu—0.13Mn | ⊚ | ◯ |
| 14 | Cu—0.3Mn | ⊚ | ◯ |
| 15 | Cu—0.5Mn | ⊚ | ◯ |
| 16 | Cu—0.9Mn | ⊚ | ◯ |
| 17 | Cu—0.05Ni | ◯ | X |
| 18 | Cu—0.13Ni | ⊚ | ◯ |
| 19 | Cu—0.3Ni | ⊚ | ◯ |
| 20 | Cu—0.5Ni | ⊚ | ◯ |
| 21 | Cu—0.9Ni | ⊚ | ◯ |
| 22 | Cu—2.1Zn—0.01Fe—0.003P | ⊚ | ◯ |
| 23 | Cu—2.1Zn—0.023Fe—0.005P | ⊚ | ⊚ |
| 24 | Cu—2.1Zn—0.1Fe—0.05P | ⊚ | ⊚ |
| 25 | Cu—2.1Zn—0.9Fe—0.5P | ⊚ | ⊚ |
| 26 | Cu—2.1Zn—1.2Fe—0.7P | ⊚ | ⊚ |
| 27 | Cu—2.1Mg—0.01Fe—0.003P | ⊚ | ◯ |
| 28 | Cu—2.1Mg—0.023Fe—0.005P | ⊚ | ⊚ |
| 29 | Cu—2.1Mg—0.1Fe—0.05P | ⊚ | ⊚ |
| 30 | Cu—2.1Mg—0.9Fe—0.4P | ⊚ | ⊚ |
| 31 | Cu—2.1Mg—1.2Fe—0.7P | ⊚ | ⊚ |
| 32 | Cu—0.5Mn—0.01Fe—0.005P | ⊚ | ◯ |
| 33 | Cu—0.5Mn—0.025Fe—0.01P | ⊚ | ⊚ |
| 34 | Cu—0.5Mn—0.1Fe—0.05P | ⊚ | ⊚ |
| 35 | Cu—0.5Mn—0.9Fe—0.4P | ⊚ | ⊚ |
| 36 | Cu—0.5Mn—1.2Fe—0.6P | ⊚ | ⊚ |

TABLE 10
Heat resistance

| | Composition of inter-connection | 250° C.-0.5 h | 350° C.-0.5 h |
|---|---|---|---|
| No. | electrode(at %) | heat treatment | heat treatment |
| 37 | Cu—0.5Ni—0.01Fe—0.005P | ⊚ | ◯ |
| 38 | Cu—0.5Ni—0.025Fe—0.01P | ⊚ | ⊚ |
| 39 | Cu—0.5Ni—0.1Fe—0.05P | ⊚ | ⊚ |
| 40 | Cu—0.5Ni—0.9Fe—0.4P | ⊚ | ⊚ |
| 41 | Cu—0.5Ni—1.2Fe—0.7P | ⊚ | ⊚ |
| 42 | Cu—0.03Zn—0.05Mg | ⊚ | ◯ |
| 43 | Cu—0.5Zn—2.3Mg | ⊚ | ⊚ |
| 44 | Cu—1.5Zn—1.0Mg | ⊚ | ⊚ |
| 45 | Cu—3.2Zn—2.3Mg | ⊚ | ⊚ |
| 46 | Cu—0.03Mn—0.04Ni | ◯ | ⊚ |
| 47 | Cu—0.1Mn—0.1Ni | ⊚ | ◯ |
| 48 | Cu—0.2Mn—0.2Ni | ⊚ | ◯ |
| 49 | Cu—0.6Mn—0.6Ni | ⊚ | ◯ |
| 50 | Cu—2.1Zn—0.01Co—0.005P | ⊚ | ◯ |
| 51 | Cu—2.1Zn—0.025Co—0.01P | ⊚ | ⊚ |
| 52 | Cu—2.1Zn—0.1Co—0.05P | ⊚ | ⊚ |
| 53 | Cu—2.1Zn—0.9Co—0.5P | ⊚ | ⊚ |
| 54 | Cu—2.1Zn—1.4Co—0.6P | ⊚ | ⊚ |
| 55 | Cu—2.1Mg—0.01Co—0.005P | ⊚ | ◯ |
| 56 | Cu—2.1Mg—0.025Co—0.01P | ⊚ | ⊚ |
| 57 | Cu—2.1Mg—0.1Co—0.05P | ⊚ | ⊚ |
| 58 | Cu—2.1Mg—0.9Co—0.4P | ⊚ | ⊚ |
| 59 | Cu—2.1Mg—1.2Co—0.7P | ⊚ | ⊚ |
| 60 | Cu—0.5Mn—0.01Co—0.005P | ⊚ | ◯ |
| 61 | Cu—0.5Mn—0.025Co—0.01P | ⊚ | ⊚ |
| 62 | Cu—0.5Mn—0.1Co—0.05P | ⊚ | ⊚ |
| 63 | Cu—0.5Mn—0.8Co—0.4P | ⊚ | ⊚ |
| 64 | Cu—0.5Mn—1.3Co—0.6P | ⊚ | ⊚ |
| 65 | Cu—0.5Ni—0.01Co—0.005P | ⊚ | ◯ |
| 66 | Cu—0.5Ni—0.025Co—0.01P | ⊚ | ⊚ |
| 67 | Cu—0.5Ni—0.1Co—0.05P | ⊚ | ⊚ |
| 68 | Cu—0.5Ni—0.9Co—0.5P | ⊚ | ⊚ |
| 69 | Cu—0.5Ni—1.3Co—0.7P | ⊚ | ⊚ |

The results for the pass/failure judgment obtained in the experiment described above are collectively shown in Tables 11 to 13. As apparent from the tables, in a case where the content of the predetermined alloy elements contained in Cu are insufficient, the effect of decreasing the contact resistivity tended to become insufficient. On the contrary, in a case where the content was excessive, the electrical resistivity of the Cu alloy film per se increased, and both of the cases did not satisfy the purpose of the invention.

Then, by properly controlling the kind and the amount of the alloying elements added to Cu, direct connection at low resistivity was possible even in a processing circumstance where oxide films were formed at the boundary between the Cu alloy film and the transparent conductive film in the display device according to the invention. Further, the heat resistance of the specimens with composite addition of Fe or Co and P was particularly satisfactory, and suitable to a case of undergoing thermal hysteresis at high temperature. Accordingly, since increase and scattering of the contact resistance between the pixel electrode (transparent electrode) and the direct interconnection portion can be minimized in the liquid crystal display device as the flat panel display device having the TFT array substrate described above, it is possible to prevent undesired effects on the quality of the display screen and the display quality can be improved remarkably.

TABLE 11

| | 250° C. × 0.5 h heat treatment | | | |
|---|---|---|---|---|
| | | Contact Characteristics | | |
| Composition of inter-connection | | Dry etching | Wet etching | Wet etching + air ashing |

| | electrode film | Electric | Avearge contact | Failure | Avearge contact | Failure | Avearge contact | Failure | Heat |
|---|---|---|---|---|---|---|---|---|---|
| No. | (at %) | resistivity | resistivity | rate | resistivity | rate | resistivity | rate | resistance |
| 1 | Cu | ◯ | ◯ | X | ◯ | ◯ | X | X | ◯ |
| 2 | Cu—0.05Zn | ◯ | ◯ | X | ◯ | ◯ | X | X | ◯ |
| 3 | Cu—0.12Zn | ◯ | ◯ | ◯ | ◯ | ◯ | ◯ | ◯ | ⊚ |
| 4 | Cu—2.1Zn | ◯ | ◯ | ◯ | ◯ | ◯ | ◯ | ◯ | ⊚ |
| 5 | Cu—3.0Zn | ◯ | ◯ | ◯ | ◯ | ◯ | ◯ | ◯ | ⊚ |
| 6 | Cu—4.0Zn | ◯ | ◯ | ◯ | ◯ | ◯ | ◯ | ◯ | ⊚ |
| 7 | Cu—0.05Mg | ◯ | ◯ | X | ◯ | ◯ | X | X | ◯ |
| 8 | Cu—0.15Mg | ◯ | ◯ | ◯ | ◯ | ◯ | ◯ | ◯ | ⊚ |
| 9 | Cu—1.3Mg | ◯ | ◯ | ◯ | ◯ | ◯ | ◯ | ◯ | ⊚ |
| 10 | Cu—3.0Mg | ◯ | ◯ | ◯ | ◯ | ◯ | ◯ | ◯ | ⊚ |
| 11 | Cu—4.7Mg | ◯ | ◯ | ◯ | ◯ | ◯ | ◯ | ◯ | ⊚ |
| 12 | Cu—0.06Mn | ◯ | ◯ | X | ◯ | ◯ | X | X | ◯ |
| 13 | Cu—0.13Mn | ◯ | ◯ | ◯ | ◯ | ◯ | ◯ | ◯ | ⊚ |
| 14 | Cu—0.3Mn | ◯ | ◯ | ◯ | ◯ | ◯ | ◯ | ◯ | ⊚ |
| 15 | Cu—0.5Mn | ◯ | ◯ | ◯ | ◯ | ◯ | ◯ | ◯ | ⊚ |
| 16 | Cu—0.9Mn | ◯ | ◯ | ◯ | ◯ | ◯ | ◯ | ◯ | ⊚ |
| 17 | Cu—0.05Ni | ◯ | ◯ | X | ◯ | ◯ | X | X | ◯ |
| 18 | Cu—0.13Ni | ◯ | ◯ | ◯ | ◯ | ◯ | ◯ | ◯ | ⊚ |
| 19 | Cu—0.3Ni | ◯ | ◯ | ◯ | ◯ | ◯ | ◯ | ◯ | ⊚ |
| 20 | Cu—0.5Ni | ◯ | ◯ | ◯ | ◯ | ◯ | ◯ | ◯ | ⊚ |
| 21 | Cu—0.9Ni | ◯ | ◯ | ◯ | ◯ | ◯ | ◯ | ◯ | ⊚ |

| | 350° C. × 0.5 h heat treatment | | | | | | | | |
|---|---|---|---|---|---|---|---|---|---|
| | | Contact Characteristics | | | | | | | |
| | | Dry etching | | Wet etching | | Wetetching + air ashing | | | |
| | Electric | Avearge contact | Failure | Avearge contact | Failure | Avearge contact | Failure | Heat | |
| No. | resistivity | resistivity | rate | resistivity | rate | resistivity | rate | resistance | Overall judgement |
| 1 | ◯ | ◯ | X | ◯ | ◯ | X | X | X | X |
| 2 | ◯ | ◯ | X | ◯ | ◯ | X | X | X | X |
| 3 | ◯ | ◯ | ◯ | ◯ | ◯ | ◯ | ◯ | ◯ | ◯ |
| 4 | ◯ | ◯ | ◯ | ◯ | ◯ | ◯ | ◯ | ◯ | ◯ |
| 5 | ◯ | ◯ | ◯ | ◯ | ◯ | ◯ | ◯ | ◯ | ◯ |
| 6 | X | ◯ | ◯ | ◯ | ◯ | ◯ | ◯ | ◯ | X |
| 7 | ◯ | ◯ | X | ◯ | ◯ | X | X | X | X |
| 8 | ◯ | ◯ | ◯ | ◯ | ◯ | ◯ | ◯ | ◯ | ◯ |
| 9 | ◯ | ◯ | ◯ | ◯ | ◯ | ◯ | ◯ | ◯ | ◯ |
| 10 | ◯ | ◯ | ◯ | ◯ | ◯ | ◯ | ◯ | ◯ | ◯ |
| 11 | X | ◯ | ◯ | ◯ | ◯ | ◯ | ◯ | ◯ | X |
| 12 | ◯ | ◯ | X | ◯ | ◯ | X | X | X | X |
| 13 | ◯ | ◯ | ◯ | ◯ | ◯ | ◯ | ◯ | ◯ | ◯ |
| 14 | ◯ | ◯ | ◯ | ◯ | ◯ | ◯ | ◯ | ◯ | ◯ |
| 15 | ◯ | ◯ | ◯ | ◯ | ◯ | ◯ | ◯ | ◯ | ◯ |
| 16 | X | ◯ | ◯ | ◯ | ◯ | ◯ | ◯ | ◯ | X |
| 17 | ◯ | ◯ | X | ◯ | ◯ | X | X | X | X |
| 18 | ◯ | ◯ | ◯ | ◯ | ◯ | ◯ | ◯ | ◯ | ◯ |
| 19 | ◯ | ◯ | ◯ | ◯ | ◯ | ◯ | ◯ | ◯ | ◯ |
| 20 | ◯ | ◯ | ◯ | ◯ | ◯ | ◯ | ◯ | ◯ | ◯ |
| 21 | X | ◯ | ◯ | ◯ | ◯ | ◯ | ◯ | ◯ | X |

TABLE 12

| | | 250° C. × 0.5 h heat treatment | | | | | | | |
|---|---|---|---|---|---|---|---|---|---|
| | | | Contact Characteristics | | | | | | |
| | Composition of inter-connection | | Dry etching | | Wet etching | | Wet etching + air ashing | | |
| | electrode film | Electric | Avearge contact | Failure | Avearge contact | Failure | Avearge contact | Failure | Heat |
| No. | (at %) | resistivity | resistivity | rate | resistivity | rate | resistivity | rate | resistance |
| 22 | Cu—2.1Zn—0.01Fe—0.003P | ◯ | ◯ | ◯ | ◯ | ◯ | ◯ | ◯ | ⊚ |
| 23 | Cu—2.1Zn—0.023Fe—0.005P | ◯ | ◯ | ◯ | ◯ | ◯ | ◯ | ◯ | ⊚ |
| 24 | Cu—2.1Zn—0.1Fe—0.05P | ◯ | ◯ | ◯ | ◯ | ◯ | ◯ | ◯ | ⊚ |
| 25 | Cu—2.1Zn—0.9Fe—0.5P | ◯ | ◯ | ◯ | ◯ | ◯ | ◯ | ◯ | ⊚ |
| 26 | Cu—2.1Zn—1.2Fe—0.7P | ◯ | ◯ | ◯ | ◯ | ◯ | ◯ | ◯ | ⊚ |
| 27 | Cu—2.1Mg—0.01Fe—0.003P | ◯ | ◯ | ◯ | ◯ | ◯ | ◯ | ◯ | ⊚ |
| 28 | Cu—2.1Mg—0.023Fe—0.005P | ◯ | ◯ | ◯ | ◯ | ◯ | ◯ | ◯ | ⊚ |
| 29 | Cu—2.1Mg—0.1Fe—0.05P | ◯ | ◯ | ◯ | ◯ | ◯ | ◯ | ◯ | ⊚ |
| 30 | Cu—2.1Mg—0.9Fe—0.4P | ◯ | ◯ | ◯ | ◯ | ◯ | ◯ | ◯ | ⊚ |
| 31 | Cu—2.1Mg—1.2Fe—0.7P | X | ◯ | ◯ | ◯ | ◯ | ◯ | ◯ | ⊚ |
| 32 | Cu—0.5Mn—0.01Fe—0.005P | ◯ | ◯ | ◯ | ◯ | ◯ | ◯ | ◯ | ⊚ |
| 33 | Cu—0.5Mn—0.025Fe—0.01P | ◯ | ◯ | ◯ | ◯ | ◯ | ◯ | ◯ | ⊚ |
| 34 | Cu—0.5Mn—0.1Fe—0.05P | ◯ | ◯ | ◯ | ◯ | ◯ | ◯ | ◯ | ⊚ |
| 35 | Cu—0.5Mn—0.9Fe—0.4P | ◯ | ◯ | ◯ | ◯ | ◯ | ◯ | ◯ | ⊚ |
| 36 | Cu—0.5Mn—1.2Fe—0.6P | ◯ | ◯ | ◯ | ◯ | ◯ | ◯ | ◯ | ⊚ |
| 37 | Cu—0.5Ni—0.01Fe—0.005P | ◯ | ◯ | ◯ | ◯ | ◯ | ◯ | ◯ | ⊚ |
| 38 | Cu—0.5Ni—0.025Fe—0.01P | ◯ | ◯ | ◯ | ◯ | ◯ | ◯ | ◯ | ⊚ |
| 39 | Cu—0.5Ni—0.1Fe—0.05P | ◯ | ◯ | ◯ | ◯ | ◯ | ◯ | ◯ | ⊚ |
| 40 | Cu—0.5Ni—0.9Fe—0.4P | ◯ | ◯ | ◯ | ◯ | ◯ | ◯ | ◯ | ⊚ |
| 41 | Cu—0.5Ni—1.2Fe—0.7P | X | ◯ | ◯ | ◯ | ◯ | ◯ | ◯ | ⊚ |
| 42 | Cu—0.03Zn—0.05Mg | ◯ | ◯ | X | ◯ | ◯ | X | X | ⊚ |
| 43 | Cu—0.5Zn—2.3Mg | ◯ | ◯ | ◯ | ◯ | ◯ | ◯ | ◯ | ⊚ |
| 44 | Cu—1.5Zn—1.0Mg | ◯ | ◯ | ◯ | ◯ | ◯ | ◯ | ◯ | ⊚ |
| 45 | Cu—3.2Zn—2.3Mg | ◯ | ◯ | ◯ | ◯ | ◯ | ◯ | ◯ | ⊚ |
| 46 | Cu—0.03Mn—0.04Ni | ◯ | ◯ | X | ◯ | ◯ | X | X | ◯ |
| 47 | Cu—0.1Mn—0.1Ni | ◯ | ◯ | ◯ | ◯ | ◯ | ◯ | ◯ | ⊚ |
| 48 | Cu—0.2Mn—0.2Ni | ◯ | ◯ | ◯ | ◯ | ◯ | ◯ | ◯ | ⊚ |
| 49 | Cu—0.6Mn—0.6Ni | ◯ | ◯ | ◯ | ◯ | ◯ | ◯ | ◯ | ⊚ |

| | 350° C. × 0.5 h heat treatment | | | | | | | | |
|---|---|---|---|---|---|---|---|---|---|
| | | Contact Characteristics | | | | | | | |
| | | Dry etching | | Wet etching | | Wet etching + air ashing | | | |
| | Electric | Avearge contact | Failure | Avearge contact | Failure | Avearge contact | Failure | Heat | Overall |
| No. | resistivity | resistivity | rate | resistivity | rate | resistivity | rate | resistance | judgement |
| 22 | ◯ | ◯ | ◯ | ◯ | ◯ | ◯ | ◯ | ◯ | ◯ |
| 23 | ◯ | ◯ | ◯ | ◯ | ◯ | ◯ | ◯ | ⊚ | ◯ |
| 24 | ◯ | ◯ | ◯ | ◯ | ◯ | ◯ | ◯ | ⊚ | ◯ |
| 25 | ◯ | ◯ | ◯ | ◯ | ◯ | ◯ | ◯ | ⊚ | ◯ |
| 26 | X | ◯ | ◯ | ◯ | ◯ | ◯ | ◯ | ⊚ | X |
| 27 | ◯ | ◯ | ◯ | ◯ | ◯ | ◯ | ◯ | ◯ | ◯ |
| 28 | ◯ | ◯ | ◯ | ◯ | ◯ | ◯ | ◯ | ⊚ | ◯ |
| 29 | ◯ | ◯ | ◯ | ◯ | ◯ | ◯ | ◯ | ⊚ | ◯ |
| 30 | ◯ | ◯ | ◯ | ◯ | ◯ | ◯ | ◯ | ⊚ | ◯ |
| 31 | X | ◯ | ◯ | ◯ | ◯ | ◯ | ◯ | ⊚ | X |
| 32 | ◯ | ◯ | ◯ | ◯ | ◯ | ◯ | ◯ | ◯ | ◯ |
| 33 | ◯ | ◯ | ◯ | ◯ | ◯ | ◯ | ◯ | ⊚ | ◯ |
| 34 | ◯ | ◯ | ◯ | ◯ | ◯ | X | X | ⊚ | ◯ |
| 35 | ◯ | ◯ | ◯ | ◯ | ◯ | ◯ | ◯ | ⊚ | ◯ |
| 36 | X | ◯ | ◯ | ◯ | ◯ | ◯ | ◯ | ⊚ | X |
| 37 | ◯ | ◯ | ◯ | ◯ | ◯ | ◯ | ◯ | ◯ | ◯ |
| 38 | ◯ | ◯ | ◯ | ◯ | ◯ | ◯ | ◯ | ⊚ | ◯ |
| 39 | ◯ | ◯ | ◯ | ◯ | ◯ | ◯ | ◯ | ⊚ | ◯ |
| 40 | ◯ | ◯ | ◯ | ◯ | ◯ | ◯ | ◯ | ⊚ | ◯ |
| 41 | X | ◯ | ◯ | ◯ | ◯ | ◯ | ◯ | ⊚ | X |
| 42 | ◯ | ◯ | X | ◯ | ◯ | X | X | ◯ | X |
| 43 | ◯ | ◯ | ◯ | ◯ | ◯ | ◯ | ◯ | ⊚ | ◯ |
| 44 | ◯ | ◯ | ◯ | ◯ | ◯ | ◯ | ◯ | ⊚ | ◯ |
| 45 | X | ◯ | ◯ | ◯ | ◯ | ◯ | ◯ | ⊚ | X |
| 46 | ◯ | ◯ | X | ◯ | ◯ | X | X | ⊚ | X |
| 47 | ◯ | ◯ | ◯ | ◯ | ◯ | ◯ | ◯ | ◯ | ◯ |
| 48 | ◯ | ◯ | ◯ | ◯ | ◯ | ◯ | ◯ | ◯ | ◯ |
| 49 | X | ◯ | ◯ | ◯ | ◯ | ◯ | ◯ | ◯ | X |

TABLE 13

| | | 250° C. × 0.5 h heat treatment | | | | | | | |
|---|---|---|---|---|---|---|---|---|---|
| | | | Contact Characteristics | | | | | | |
| | Compostion of inter-connection | | Dry etching | | Wet etching | | Wet etching + air ashing | | |
| | electrode film | Electric | Average contact | Failure | Average contact | Failure | Average contact | Failaure | Heat |
| No. | (at %) | resistivity | resistivity | rate | resistivity | rate | resistivity | rate | resistance |
| 50 | Cu—2.1Zn—0.01Co—0.005P | ◯ | ◯ | ◯ | ◯ | ◯ | ◯ | ◯ | ⊚ |
| 51 | Cu—2.1Zn—0.025Co—0.01P | ◯ | ◯ | ◯ | ◯ | ◯ | ◯ | ◯ | ⊚ |
| 52 | Cu—2.1Zn—0.1Co—0.05P | ◯ | ◯ | ◯ | ◯ | ◯ | ◯ | ◯ | ⊚ |
| 53 | Cu—2.1Zn—0.9Co—0.5P | ◯ | ◯ | ◯ | ◯ | ◯ | ◯ | ◯ | ⊚ |
| 54 | Cu—2.1Zn—1.4Co—0.6P | X | ◯ | ◯ | ◯ | ◯ | ◯ | ◯ | ⊚ |
| 55 | Cu—2.1Mg—0.01Co—0.005P | ◯ | ◯ | ◯ | ◯ | ◯ | ◯ | ◯ | ⊚ |
| 56 | Cu—2.1Mg—0.025Co—0.01P | ◯ | ◯ | ◯ | ◯ | ◯ | ◯ | ◯ | ⊚ |
| 57 | Cu—2.1Mg—0.1Co—0.05P | ◯ | ◯ | ◯ | ◯ | ◯ | ◯ | ◯ | ⊚ |
| 58 | Cu—2.1Mg—0.9Co—0.4P | ◯ | ◯ | ◯ | ◯ | ◯ | ◯ | ◯ | ⊚ |
| 59 | Cu—2.1Mg—1.2Co—0.7P | X | ◯ | ◯ | ◯ | ◯ | ◯ | ◯ | ⊚ |
| 60 | Cu—0.5Mn—0.01Co—0.005P | ◯ | ◯ | ◯ | ◯ | ◯ | ◯ | ◯ | ⊚ |
| 61 | Cu—0.5Mn—0.025Co—0.01P | ◯ | ◯ | ◯ | ◯ | ◯ | ◯ | ◯ | ⊚ |
| 62 | Cu—0.5Mn—0.1Co—0.05P | ◯ | ◯ | ◯ | ◯ | ◯ | ◯ | ◯ | ⊚ |
| 63 | Cu—0.5Mn—0.8Co—0.4P | ◯ | ◯ | ◯ | ◯ | ◯ | ◯ | ◯ | ⊚ |
| 64 | Cu—0.5Mn—1.3Co—0.6P | X | ◯ | ◯ | ◯ | ◯ | ◯ | ◯ | ⊚ |
| 65 | Cu—0.5Ni—0.01Co—0.005P | ◯ | ◯ | ◯ | ◯ | ◯ | ◯ | ◯ | ⊚ |
| 66 | Cu—0.5Ni—0.025Co—0.01P | ◯ | ◯ | ◯ | ◯ | ◯ | ◯ | ◯ | ⊚ |
| 67 | Cu—0.5Ni—0.1Co—0.05P | ◯ | ◯ | ◯ | ◯ | ◯ | ◯ | ◯ | ⊚ |
| 68 | Cu—0.5Ni—0.9Co—0.5P | ◯ | ◯ | ◯ | ◯ | ◯ | ◯ | ◯ | ⊚ |
| 69 | Cu—0.5Ni—1.3Co—0.7P | X | ◯ | ◯ | ◯ | ◯ | ◯ | ◯ | ⊚ |

| | 350° C. × 0.5 h heat treatment | | | | | | | | |
|---|---|---|---|---|---|---|---|---|---|
| | | Contact Characteristics | | | | | | | |
| | | Dry etching | | Wet etching | | Wet etching + air ashing | | | |
| | | Average contact | Failure | Average contact | Failure | Average contact | Failure | | |
| No. | Electric resistivity | resistivity | rate | resistivity | rate | resistivity | rate | Heat resistance | Overall judgement |
| 50 | ◯ | ◯ | ◯ | ◯ | ◯ | ◯ | ◯ | ◯ | ◯ |
| 51 | ◯ | ◯ | ◯ | ◯ | ◯ | ◯ | ◯ | ⊚ | ◯ |
| 52 | ◯ | ◯ | ◯ | ◯ | ◯ | ◯ | ◯ | ⊚ | ◯ |
| 53 | ◯ | ◯ | ◯ | ◯ | ◯ | ◯ | ◯ | ⊚ | ◯ |
| 54 | X | ◯ | ◯ | ◯ | ◯ | ◯ | ◯ | ⊚ | X |
| 55 | ◯ | ◯ | ◯ | ◯ | ◯ | ◯ | ◯ | ◯ | ◯ |
| 56 | ◯ | ◯ | ◯ | ◯ | ◯ | ◯ | ◯ | ⊚ | ◯ |
| 57 | ◯ | ◯ | ◯ | ◯ | ◯ | ◯ | ◯ | ⊚ | ◯ |
| 58 | ◯ | ◯ | ◯ | ◯ | ◯ | ◯ | ◯ | ⊚ | ◯ |
| 59 | X | ◯ | ◯ | ◯ | ◯ | ◯ | ◯ | ⊚ | X |
| 60 | ◯ | ◯ | ◯ | ◯ | ◯ | ◯ | ◯ | ◯ | ◯ |
| 61 | ◯ | ◯ | ◯ | ◯ | ◯ | ◯ | ◯ | ⊚ | ◯ |
| 62 | ◯ | ◯ | ◯ | ◯ | ◯ | ◯ | ◯ | ⊚ | ◯ |
| 63 | ◯ | ◯ | ◯ | ◯ | ◯ | ◯ | ◯ | ⊚ | ◯ |
| 64 | X | ◯ | ◯ | ◯ | ◯ | ◯ | ◯ | ⊚ | X |
| 65 | ◯ | ◯ | ◯ | ◯ | ◯ | ◯ | ◯ | ◯ | ◯ |
| 66 | ◯ | ◯ | ◯ | ◯ | ◯ | ◯ | ◯ | ⊚ | ◯ |
| 67 | ◯ | ◯ | ◯ | ◯ | ◯ | ◯ | ◯ | ⊚ | ◯ |
| 68 | ◯ | ◯ | ◯ | ◯ | ◯ | ◯ | ◯ | ⊚ | ◯ |
| 69 | X | ◯ | ◯ | ◯ | ◯ | ◯ | ◯ | ⊚ | X |

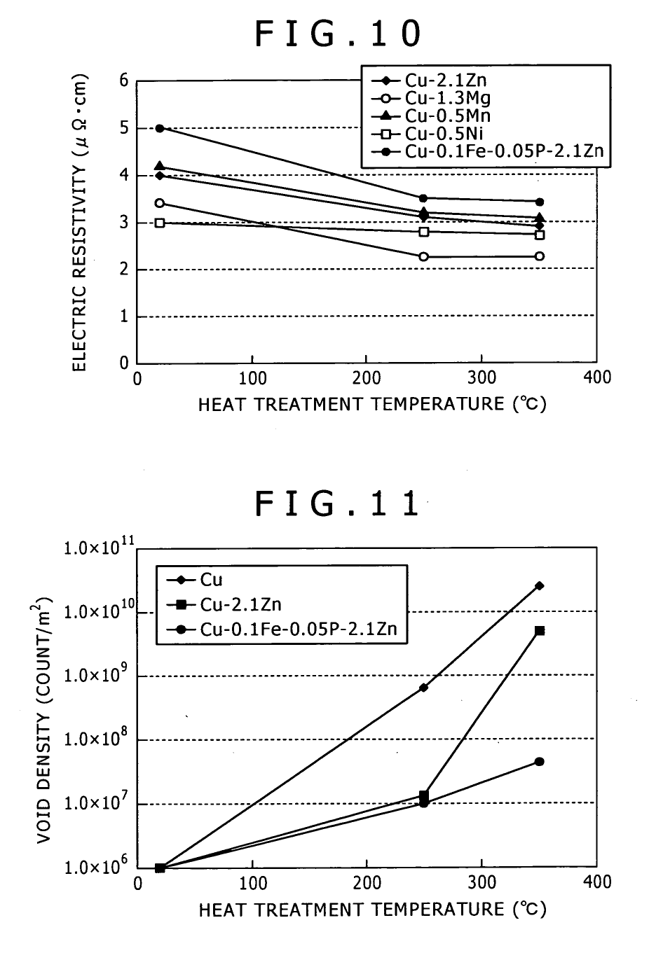

FIG. 10 is a graph showing a relation between the heat treatment temperature and the electrical resistivity for typical specimens in the experiment described above. As can be seen from the graph, the electricalal resistivity apparently lowers in the thermal hysteresis between 100° C. and 400° C. for each of the specimens. In the general steps for manufacturing liquid crystal displays, a heat treatment temperature about at 250 to 350° C. is applied after forming the Cu interconnection.

FIG. 11 is a graph showing a relation between the heat treatment temperature and the void density for typical specimens in the experiment described above. At the heat treatment temperature of 250° C., generation of voids can be suppressed by adding one or more of elements selected from Zn, Mg, Mn, and Ni. Further, in a case of undergoing the thermal hysteresis which at a further higher temperature of 350° C., it can be seen that generation of the voids can be suppressed greatly by using the Cu alloy with addition of Fe and P.

As apparent from the results of the experiment, direct connection at low resistivity is possible at the boundary between the Cu alloy film and the transparent conductive film in the display device according to the invention without using the barrier metal as in the existent examples. Accordingly, since increase in the contact resistance can be minimized between the pixel electrode (transparent electrode film) and the connecting interconnection portion in the liquid crystal display device as the flat panel display device having the TFT array substrate, undesired effects on the quality of the display screen can be prevented to remarkably improve the display quality.

What is claimed is:

1. A display device in which interconnection—electrode comprising a Cu alloy film and a transparent conductive film are directly connected not by way of a refractory metal thin film, wherein said Cu alloy film contains Zn and/or Mg in a total amount from 0.1 to 3.0 at %.

2. A display device in which interconnection—electrode comprising a Cu alloy film and a transparent conductive film are directly connected not by way of a refractory metal thin film, wherein said Cu alloy film contains Ni and/or Mn in a total amount from 0.1 to 0.5 at %.

3. A display device according to claim 1, wherein said Cu alloy film contains Fe and/or Co in a total amount from 0.02 to 1.0 at %, and 0.005 to 0.5 at % of P.

4. A display device according to claim 2, wherein said Cu alloy film contains Fe and/or Co in a total amount from 0.02 to 1.0 at %, and 0.005 to 0.5 at % of P.

5. A display device according to claim 1, wherein the transparent conductive film is indium tin oxide (ITO) or indium zinc oxide (IZO).

6. A display device according to claim 2, wherein the transparent conductive film is indium tin oxide (ITO) or indium zinc oxide (IZO).

7. A display device according to claim 1, wherein a transparent conductive film is laminated on the Cu alloy film to form a tab connection electrode.

8. A display device according to claim 2, wherein a transparent conductive film is laminated on the Cu alloy film to form a tab connection electrode.
